(19) United States
(12) Patent Application Publication
(10) Pub. No.: US 2025/0172583 A1
(43) Pub. Date: May 29, 2025

(54) PROCESSING SYSTEM, STORAGE MEDIUM STORING PROGRAM, AND PROCESSING METHOD

(71) Applicant: SEIKO EPSON CORPORATION, Tokyo (JP)

(72) Inventor: Masayoshi Todorokihara, Suwa-shi (JP)

(21) Appl. No.: 18/960,269

(22) Filed: Nov. 26, 2024

(30) Foreign Application Priority Data
Nov. 29, 2023 (JP) 2023-201967

(51) Int. Cl. G01P 15/097; G01P 3/02

(52) U.S. Cl. CPC G01P 15/097; G01P 3/02

(57) ABSTRACT

A processing system includes: an acquisition unit, an arithmetic unit, an output unit. The acquisition unit that acquires first vibration information of a first channel and second vibration information of a second channel about vibration of an object. The arithmetic unit that calculates a spectrogram including at least one of a cross-power spectrogram, a cross-phase spectrogram, and a coherence spectrogram of the first vibration information and the second vibration information. The output unit that outputs presentation information on at least one of condition monitoring, quality control, and predictive maintenance of the object, based on the spectrogram.

The present application is based on, and claims priority from JP Application Serial Number 2023-201967, filed Nov. 29, 2023, the disclosure of which is hereby incorporated by reference herein in its entirety.

### BACKGROUND

### 1. Technical Field

The present disclosure relates to a processing system, a storage medium storing a program, a processing method, and the like.

### 2. Related Art

JP-A-2022-154180 discloses an inspection method for inspecting an automobile component having an operating part such as a motor. In the inspection method, a microphone installed near an inspection object acquires waveform data on the operating sound of the inspection object, and a complex spectrogram is generated by performing short-time Fourier transform on the waveform data. Then, a predetermined phase feature amount is calculated based on the complex spectrogram, and the phase feature amount is differentiated in a frequency direction to calculate a group delay. This group delay is subjected to smoothing filtering, and the intensity level of an abnormal sound component is calculated based on the group delay after the smoothing filtering.

In JP-A-2022-154180, waveform data on one channel acquired by the microphone is used for the inspection. JP-A-2022-154180 does not disclose condition monitoring, quality control, or predictive maintenance performed on the object based on vibration analysis using vibration information on more than one channel.

### SUMMARY

An aspect of the present disclosure is a processing system including: an acquisition unit that acquires first vibration information of a first channel and second vibration information of a second channel about vibration of an object; an arithmetic unit that calculates a spectrogram including at least one of a cross-power spectrogram, a cross-phase spectrogram, and a coherence spectrogram of the first vibration information and the second vibration information; and an output unit that outputs presentation information on at least one of condition monitoring, quality control, and predictive maintenance of the object, based on the spectrogram.

Another aspect of the present disclosure is a non-transitory computer-readable storage medium storing a program for causing a computer to function as: an acquisition unit that acquires first vibration information of a first channel and second vibration information of a second channel about vibration of an object; an arithmetic unit that calculates a spectrogram including at least one of a cross-power spectrogram, a cross-phase spectrogram, and a coherence spectrogram of the first vibration information and the second vibration information; and an output unit that outputs presentation information on at least one of condition monitoring, quality control, and predictive maintenance of the object, based on the spectrogram.

Still another of the present disclosure is a processing method including: acquiring first vibration information of a first channel and second vibration information of a second channel about vibration of an object; calculating a spectrogram including at least one of a cross-power spectrogram, a cross-phase spectrogram, and a coherence spectrogram of the first vibration information and the second vibration information; and outputting presentation information on at least one of condition monitoring, quality control, and predictive maintenance of the object, based on the spectrogram.

### BRIEF DESCRIPTION OF THE DRAWINGS

FIG. 1 is an explanatory diagram of a sensor that detects vibration of an object.

FIG. 2 is an explanatory diagram of a sensor that detects vibration of an object.

FIG. 3 is an explanatory diagram of a sensor that detects vibration of an object.

FIG. 4 illustrates a configuration example of a processing system.

FIG. 5 illustrates a first processing flow example executed by a processing unit.

FIG. 6 illustrates a second processing flow example executed by the processing unit.

FIG. 7 illustrates a third processing flow example executed by the processing unit.

FIG. 8 illustrates a configuration example of an experimental apparatus.

FIG. 9 illustrates an example of a spectrogram obtained from vibration data outputted by a first vibration sensor.

FIG. 10 illustrates an example of a spectrogram obtained from vibration data outputted by the first vibration sensor.

FIG. 11 illustrates an example of a spectrogram obtained from vibration data outputted by the first vibration sensor.

FIG. 12 illustrates spectrograms of the first vibration sensor immediately after and 15 minutes after start of measurement.

FIG. 13 illustrates spectrograms of the first vibration sensor 30 minutes after and 60 minutes after start of measurement.

FIG. 14 illustrates a difference between a reference spectrogram and the spectrograms of the first vibration sensor immediately after and 15 minutes after start of measurement.

FIG. 15 illustrates a difference between the reference spectrogram and the spectrograms of the first vibration sensor 30 minutes after and 60 minutes after start of measurement.

FIG. 16 illustrates an example of a spectrogram obtained from vibration data output by a second vibration sensor.

FIG. 17 illustrates an example of a spectrogram obtained from vibration data output by the second vibration sensor.

FIG. 18 illustrates an example of a spectrogram obtained from vibration data output by the second vibration sensor.

FIG. 19 illustrates spectrograms of the second vibration sensor immediately after and 15 minutes after start of measurement.

FIG. 20 illustrates spectrograms of the second vibration sensor 30 minutes after and 60 minutes after start of measurement.

FIG. 21 illustrates a difference between the spectrogram of the first vibration sensor and the spectrogram of the second vibration sensor immediately after and 15 minutes after start of measurement.

FIG. 22 illustrates a difference between the spectrogram of the first vibration sensor and the spectrogram of the second vibration sensor 30 minutes after and 60 minutes after start of measurement.

FIG. 23 illustrates a first example of presentation information.

FIG. 24 illustrates a second example of presentation information.

FIG. 25 illustrates the second example of presentation information.

### DESCRIPTION OF EMBODIMENTS

A preferred embodiment of the present disclosure will be described in detail below. Note that the present embodiment described below does not unduly limit the contents described in the scope of the appended claims, and all the configurations described in the present embodiment are not necessarily essential components.

### 1. Processing System

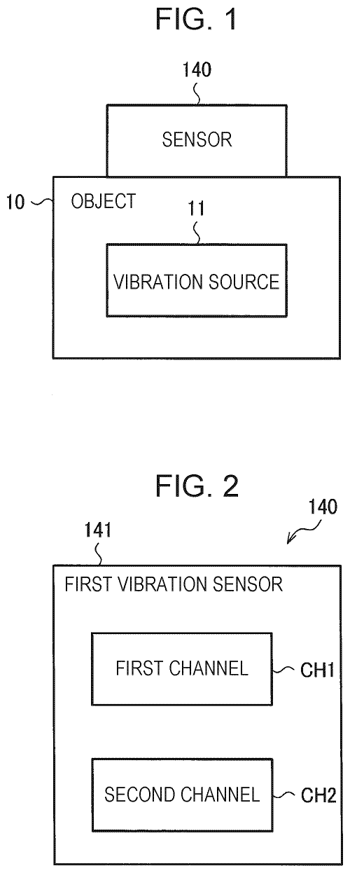

FIGS. 1 to 3 are explanatory diagrams of a sensor that detects vibration of an object. As illustrated in FIG. 1, an object 10 includes a vibration source 11 that causes vibration through mechanical operation, for example. The sensor 140 detects the vibration of the object 10 caused by the vibration source 11. The vibration source 11 is, for example, a motor, an engine, a turbine, or the like. Alternatively, the object 10 does not have to include the vibration source 11, and instead the sensor 140 may detect vibration applied from outside the object 10.

The object 10 is, for example, the vibration source 11 itself, that is, a motor, an engine, a turbine, or the like. Alternatively, the object 10 is a machine, a device, an apparatus or the like that includes the vibration source 11. The object 10 is, for example, household appliance or industrial equipment, such as a printer, air conditioner, robot, pump, belt conveyor, or processing equipment. Alternatively, the object 10 is, for example, a mobile body such as an automobile or airplane, or an industrial installation such as a generator or manufacturing plant. Alternatively, the object 10 may be a structure that vibrates due to an external force, such as a building, road, or bridge.

The sensor 140 detects acceleration, velocity, displacement, angular acceleration, angular velocity, or angle, and outputs a signal indicating the detected physical quantity as vibration information. The sensor 140 may be a sensor that detects one type of physical quantity, or a sensor that detects a plurality of types of physical quantities. The sensor 140 may also be a sensor that detects a physical quantity on one axis, or a sensor that detects physical quantities on two or more axes. The sensor 140 outputs vibration information from one or a plurality of channels. One channel is a channel to output a signal of one type of physical quantity on one axis.

FIG. 2 illustrates a first configuration example of a sensor having two channels. The sensor 140 includes a first vibration sensor 141, which has a first channel CH1 and a second channel CH2. The first vibration sensor 141 may have three or more channels.

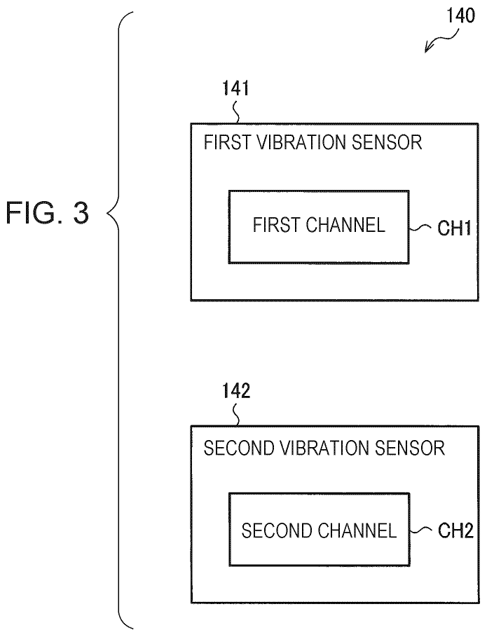

FIG. 3 illustrates a second configuration example of a sensor having two channels. The sensor 140 includes a first vibration sensor 141 and a second vibration sensor 142. The first vibration sensor 141 has a first channel CH1. The second vibration sensor 142 has a second channel CH2. The sensor 140 may include three or more vibration sensors, and each vibration sensor may have two or more channels.

Hereinafter, each of the first vibration sensor 141 and the second vibration sensor 142 will also be simply referred to as the vibration sensor.

The vibration sensor may be an acceleration sensor or gyro sensor using a quartz oscillator as a detection element, or an acceleration sensor or gyro sensor using a MEMS as a detection element. The vibration sensor may also be an IMU that combines an acceleration sensor and a gyro sensor into a unit. The vibration sensor may detect velocity or displacement by integrating the acceleration detected by the detection element, or may use a detection element that detects velocity and the like. The vibration sensor may detect angular acceleration or angle by differentiating or integrating the angular velocity detected by the detection element, or may use a detection element that detects angular acceleration and the like. One example of the acceleration sensor is a sensor that detects acceleration by measuring a vibration frequency, which changes with the stress applied to the quartz oscillator. One example of the gyro sensor is a sensor that detects an angular velocity by detecting Coriolis force applied to the quartz oscillator. Another example of the acceleration sensor or gyro sensor is a sensor in which a mass portion and electrodes are formed by MEMS, and acceleration or angular velocity is detected by detecting an electrostatic capacitance between the electrodes that changes with the inertial force applied to the mass portion.

The vibration sensor is assumed to be attached so as to be in contact with the object 10, but is not limited to such a configuration. The vibration sensor needs only be configured in a state where vibration is transmitted from the object 10 to the vibration sensor. The first vibration sensor 141 and the second vibration sensor 142 are attached at different positions on the object 10. One vibration sensor is a sensor unit attached at a certain position on the object 10. However, one vibration sensor may include a plurality of sensor units attached at substantially the same position on the object 10.

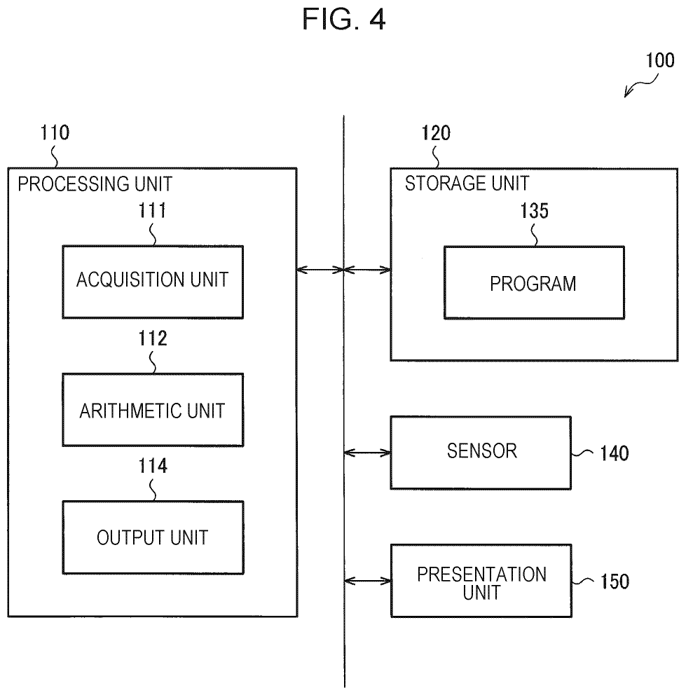

FIG. 4 illustrates a configuration example of a processing system. A processing system 100 infers a state of the object by analyzing vibration information of the object. A detailed example of the state will be described later. The processing system 100 includes a processing unit 110, a storage unit 120, a sensor 140, and a presentation unit 150. The sensor 140 may be provided outside the processing system 100 and connected to the processing system 100 via a cable, a network, or the like.

The processing unit 110 includes an acquisition unit 111, an arithmetic unit 112, and an output unit 114.

The acquisition unit 111 acquires vibration information of the object from the sensor 140 by receiving a physical quantity signal outputted by the sensor 140. The sensor 140 may output either an analog signal or digital data. When receiving an analog signal, the acquisition unit 111 may include an A/D converter that A/D-converts the analog signal into digital data. The acquisition unit 111 acquires at least first vibration information of a first channel and second vibration information of a second channel, and outputs these information to the arithmetic unit 112. The vibration information is time-series vibration data indicating the acceleration, velocity, displacement, angular acceleration, angular velocity, or angle detected by the sensor 140. The acquisition unit 111 may acquire vibration information of three or more channels.

The arithmetic unit 112 calculates at least one of a cross-power spectrogram, a cross-phase spectrogram, and a coherence spectrogram from the first vibration information and the second vibration information. In addition to the above, the arithmetic unit 112 may calculate an amplitude, power, or phase spectrogram from the first vibration information, or may calculate an amplitude, power, or phase spectrogram from the second vibration information.

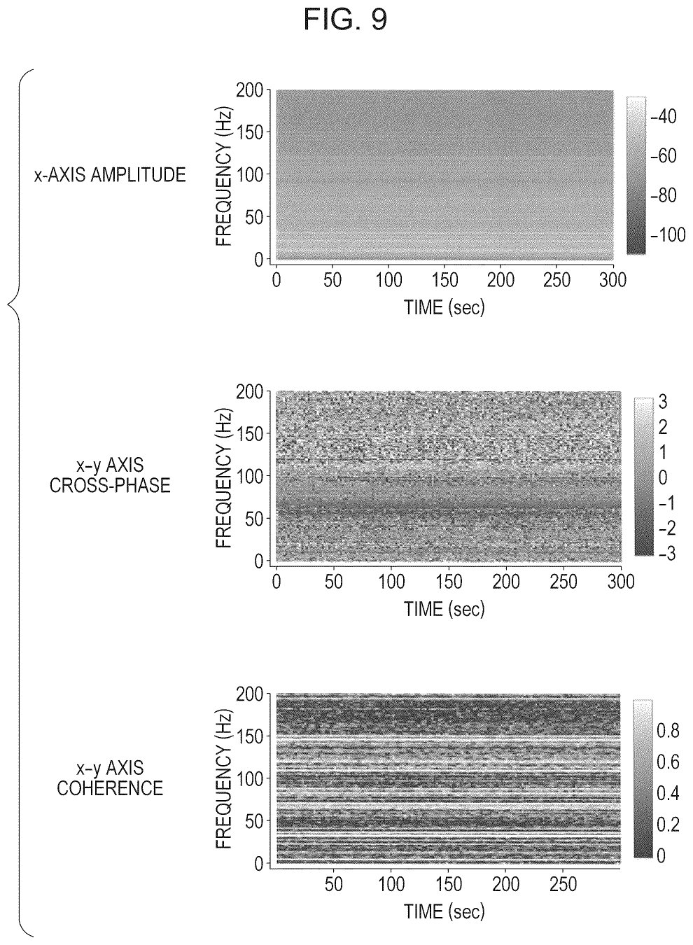

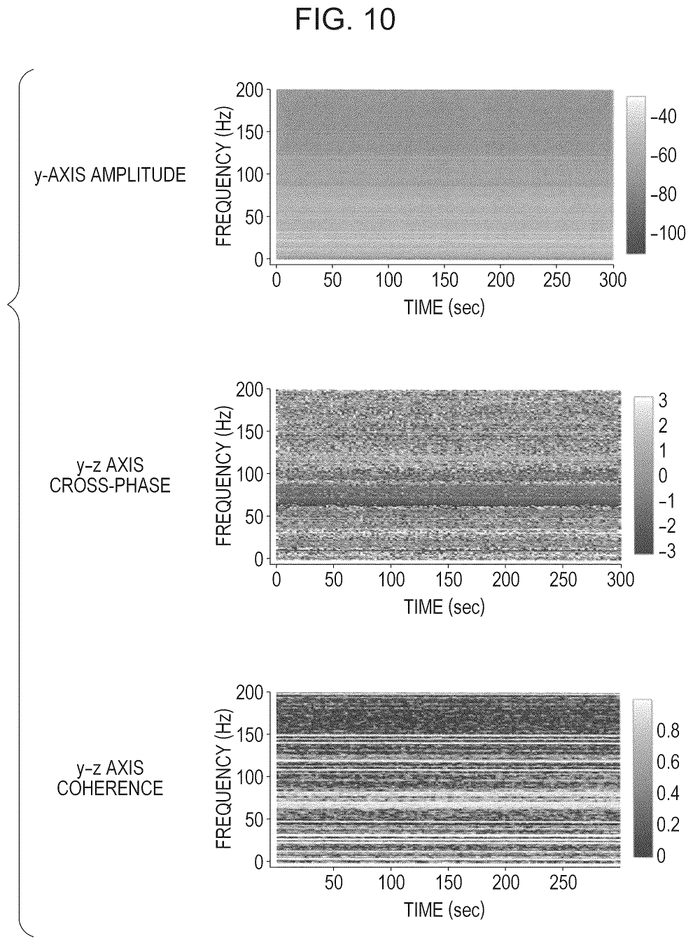

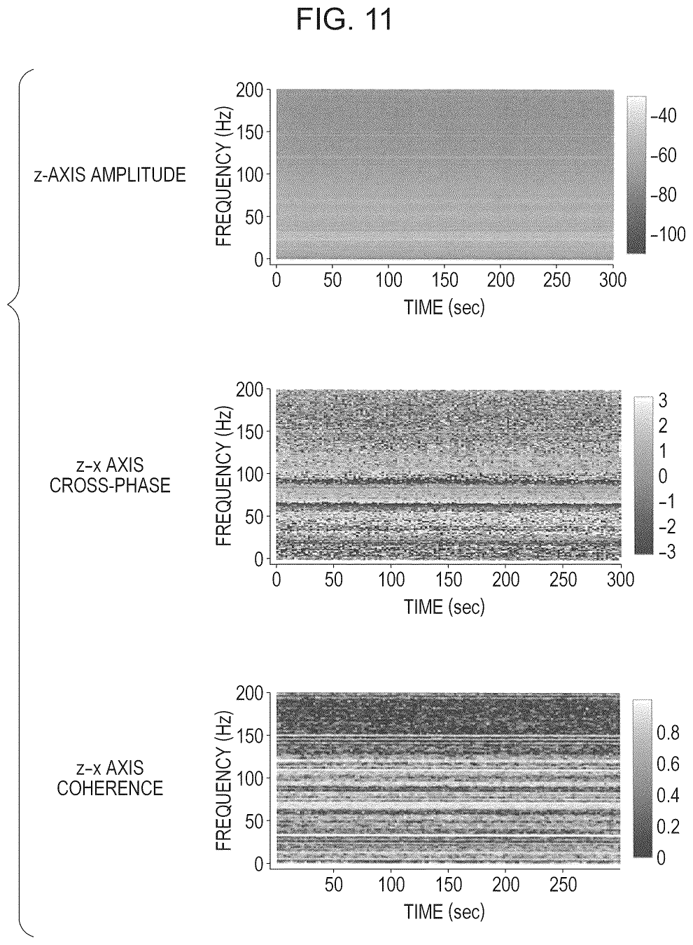

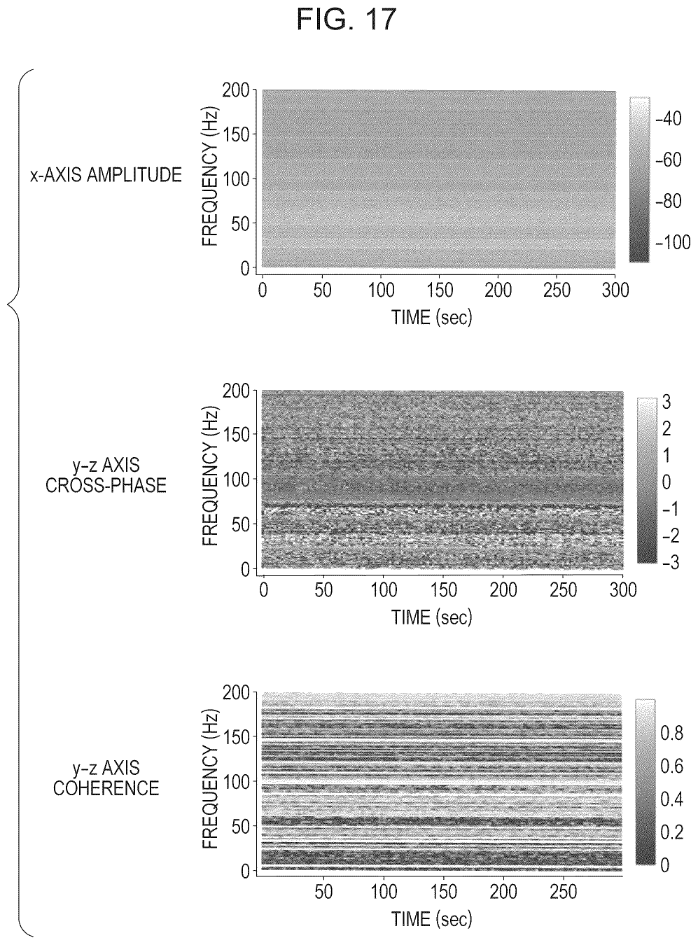

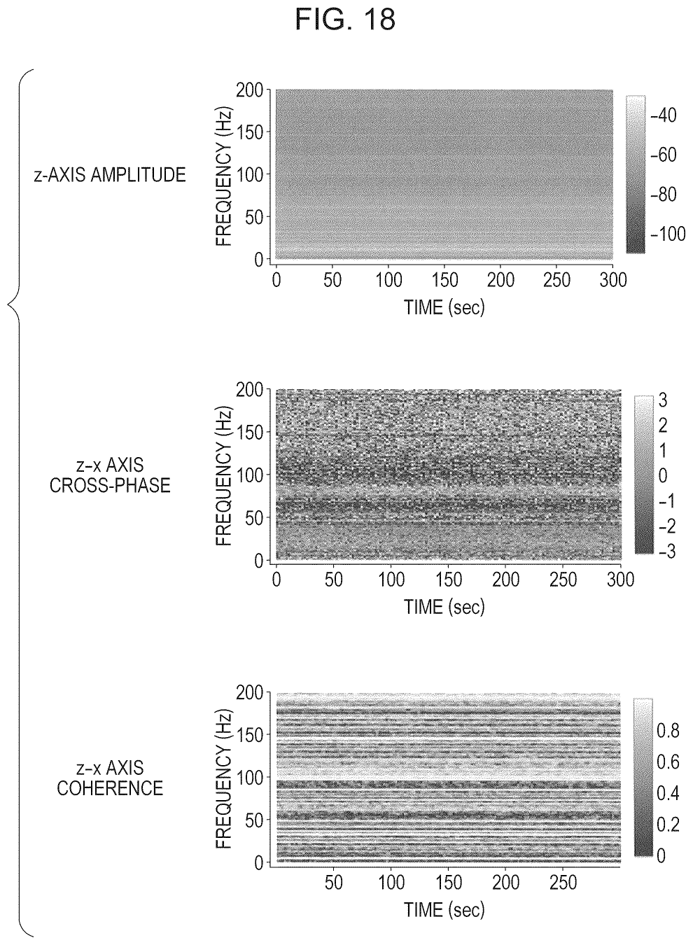

Detailed examples of spectrograms will be described later with reference to FIGS. 9 to 22. A detailed method for calculating various spectrograms will also be described later. Here, an overview of a spectrogram will be described. A spectrogram is a representation of changes in a spectrum over time by obtaining spectra one after another while shifting a cut-out range of a time-series signal in a time direction. In general, the horizontal axis represents time and the vertical axis represents frequency. The signal intensity is often represented by colors and shading. A spectrum is a distribution of frequency components, represented as a function of frequency, obtained by decomposing a time-series signal according to predetermined arithmetic rules such as the Fourier transform.

More specifically, a spectrogram is two-dimensional data in which data is arranged at each point on the time axis and frequency axis. A row of data in the frequency axis direction at a certain time represents a vibration spectrum at that time. A spectrogram is generated by acquiring spectra in time series. In an amplitude spectrogram, for example, data at each point is amplitude data. In a phase spectrogram, data at each point is phase data. Note that when a plurality of spectrograms are acquired, such as when a multi-axis sensor is used, the plurality of spectrograms may be superimposed in a depth direction to create three-dimensional data.

Phase-related spectrograms include a phase spectrogram, a cross-phase spectrogram, and a cross-power spectrogram. The phase spectrogram represents frequency characteristics of a phase in vibration data of one channel. The cross-phase spectrogram represents frequency characteristics of a phase difference between a plurality of channels as an angle. The cross-power spectrogram represents frequency characteristics of the phase difference and magnitude between the plurality of channels. The cross-power spectrogram is obtained by calculating the product of the Fourier transform of the vibration data of one channel and the complex conjugate of the Fourier transform of the vibration data of the other channel.

Amplitude-related spectrograms include an amplitude spectrogram, a power spectrogram, and a cross-power spectrogram. The amplitude spectrogram represents frequency characteristics of an amplitude in the vibration data of one channel. The power spectrogram represents frequency characteristics of power in the vibration data of one channel. The cross-power spectrogram is as described above.

A coherence spectrogram is a cross-power spectrogram normalized by the product of powers of signals.

The arithmetic unit 112 converts the spectrogram into image data using a color map or the like, and outputs the image data to the output unit 114. In the image data of the spectrogram, each point on the time axis and the frequency axis corresponds to a pixel. The color map is a map that associates data values in the spectrogram with color data.

The number of pixels in the frequency direction of the spectrogram may be greater than the number of pixels in the time direction. For example, the arithmetic unit 112 may generate a spectrogram in which the number of pixels in the frequency direction and the number of pixels in the time direction are the same, and compress the spectrogram in the time direction. Alternatively, the arithmetic unit 112 may generate a spectrogram, from the vibration data, in which the number of pixels in the frequency direction is greater than the number of pixels in the time direction. It is assumed that there is more information about the vibration state in the frequency direction than in the time direction. For this reason, it is desirable for the resolution in the frequency direction of the spectrogram to be higher than the resolution in the time direction.

The arithmetic unit 112 may output the spectrogram to the output unit 114 without converting the spectrogram with the color map, regarding the spectrogram itself as image data. The arithmetic unit 112 may also convert the phase-related spectrogram to image data using a non-cyclic color map. In the image data after conversion with the color map, each pixel generally has three elements. However, when the value of the spectrogram is a complex number, values corresponding to a real part and an imaginary part may be converted as image data having two elements. Alternatively, two grayscale images may be used, each having values corresponding to a real part and an imaginary part. Since a complex number includes phase information, the phase can be handled without explicitly calculating the phase θ. The number of elements is reduced, which saves memory usage.

The output unit 114 outputs presentation information to a user to the presentation unit 150 based on the spectrogram from the arithmetic unit 112. The output unit 114 analyzes the vibration state from the spectrogram and generates presentation information based on the analysis result. The vibration state is a state related to at least one of condition monitoring, quality control, and predictive maintenance of the object. That is, the presentation information is information related to at least one of condition monitoring, quality control, and predictive maintenance of the object. Detailed examples of condition monitoring, quality control, and predictive maintenance will be described later. For example, the output unit 114 classifies which one of a plurality of vibration states the vibration state of the object belongs to, or detects an abnormality or failure of the object. The classification result is a probability of each vibration state or a flag indicating which vibration state it is. The detection result is a flag or the like indicating whether an abnormality or failure has been detected. The presentation information is information for presenting these results to the user.

Various methods are assumed for analyzing the vibration state from the spectrogram. The output unit 114 classifies or detects the vibration state based on, for example, statistical information acquired from the spectrogram or its changes over time. The statistical information include an average value, a median value, a minimum value, a maximum value, a variance, a standard deviation, a histogram, and the like. These statistical information may be calculated from a data string arranged in the time direction or the frequency direction in the spectrogram, or may be calculated from data of the entire or partial region of the spectrogram. The output unit 114 classifies or detects the vibration state by using threshold processing, pattern matching, AI recognition, or the like on the statistical information or its changes over time, for example.

Alternatively, the output unit 114 classifies or detects the vibration state based on changes in the spectrogram over time in a specific frequency range. The specific frequency range is a frequency range that easily changes under the influence of the vibration state in the frequency characteristics of the vibration. The specific frequency range is a frequency range including or in the vicinity of a resonant frequency of the object, a frequency range including or in the vicinity of the vibration frequency of the vibration source, a frequency range including or in the vicinity of a harmonic frequency of the vibration frequency of the vibration source, or the like but is not limited thereto. The changes in the spectrogram over time are changes over time within one spectrogram obtained in a certain time range. Alternatively, the changes in the spectrogram over time are changes over time in first to n-th spectrograms of a time series when the first to n-th spectrograms are obtained in first to n-th time ranges of the time series, where n is an integer of two or more.

Alternatively, the output unit 114 may input the spectrogram to a learned model, and the learned model may output the above classification result or detection result by inference based on the spectrogram. In a learning stage, a learning system generates a learned model by training a model in advance using teacher data. The learning system is a computer or a cloud system in which a plurality of computers are connected via a network or the like. The teacher data includes a plurality of spectrograms and a correct answer label for each spectrogram. The correct answer label in a classifier is, for example, a flag indicating which one of the plurality of vibration states applies. The correct answer label in a detector is, for example, a flag indicating whether the object is in an abnormal state or broken.

The learned model is a neural network for image recognition using deep learning. An example of such a neural network for image recognition is CNN or ViT. CNN is the abbreviation that stands for Convolutional Neural Network. ViT is the abbreviation that stands for Vision Transformer. Transformers are used for models in various fields, but those used for image recognition are collectively called ViT.

The presentation unit 150 presents the presentation information from the output unit 114 to the user. The presentation unit 150 is, for example, a display, a speaker, a lamp, a vibrator, or the like. The presentation information indicates the classification result or detection result described above by numerical values, characters, colors, images, sound, light, vibration, or the like. The output unit 114 may store the classification result of the vibration state, the detection result of the vibration state, or the presentation information generated therefrom in a memory or storage. The memory or storage may be shared with the storage unit 120 described below.

The storage unit 120 stores a program 135 in which the functions of each unit in the processing unit 110 are described. The processing unit 110 executes the program 135 read from the storage unit 120 to realize the processing of the acquisition unit 111, the arithmetic unit 112, and the output unit 114. The program 135 may include the learned model described above.

Various configurations may be adopted as a hardware configuration of the processing system 100. The processing system 100 is, for example, a computer or a cloud system in which a plurality of computers are connected via a network or the like. The computer is not limited to a general-purpose computer such as a personal computer, but may be a computer dedicated to performing the vibration analysis of this embodiment, or a computer built into a specific device or the like.

The processing unit 110 is, for example, a processor. The processor includes, for example, one or more of a CPU, a GPU, a microcomputer, a DSP, an ASIC, an FPGA, or the like. CPU is the abbreviation that stands for Central Processing Unit. GPU is the abbreviation that stands for Graphics Processing Unit. DSP is the abbreviation that stands for Digital Signal Processor. ASIC is the abbreviation that stands for Application Specific Integrated Circuit. FPGA is the abbreviation that stands for Field Programmable Gate Array. The storage unit 120 stores the program 135 in which the functions of each unit in the processing unit 110 are described. The processor executes the program 135 stored in the storage unit 120 to realize the functions of each unit in the processing unit 110 as processing.

The processing unit 110 is not limited to software processing as described above, and may be a circuit that implements the functions of each unit in hardware. In that case, the storage unit 120 does not need to store the program.

The storage unit 120 is a memory or a register. The memory is a volatile memory such as a RAM, or a non-volatile memory such as an OTP memory or an EEPROM. RAM is the abbreviation that stands for Random Access Memory. OTP is the abbreviation that stands for One Time Programmable. EEPROM is the abbreviation that stands for Electrically Erasable Programmable Read Only Memory.

The program 135 may be stored in a non-transitory information storage medium that is a computer-readable medium. The information storage medium is, for example, an optical disk, a memory card, a hard disk drive, or a non-volatile semiconductor memory.

### 2. Processing Flow

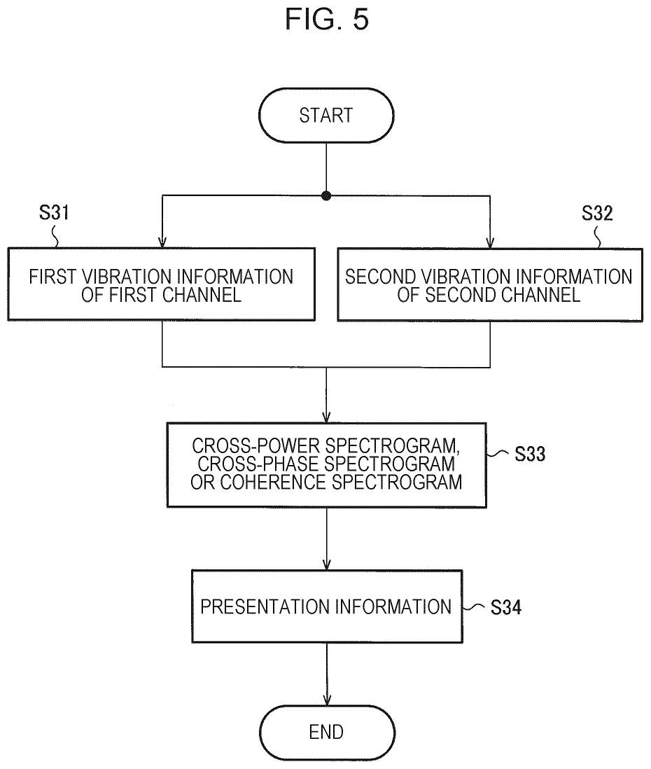

FIG. 5 illustrates a first processing flow example executed by the processing unit. In steps S31 and S32, the acquisition unit 111 acquires first vibration information of the first channel and second vibration information of the second channel from the sensor 140. The first vibration information and the second vibration information are, for example, vibration information at the same time. However, this flow may also be applied to vibration information that is not at the same time.

In step S33, the arithmetic unit 112 calculates a cross-power spectrogram, a cross-phase spectrogram or a coherence spectrogram from the first vibration information and the second vibration information.

In step S34, the output unit 114 analyzes the spectrogram outputted by the arithmetic unit 112, and outputs presentation information to the presentation unit 150 based on the result.

Note that the arithmetic unit 112 may obtain first to m-th time spectrograms corresponding to first to m-th times. The output unit 114 may output presentation information based on the first to m-th time spectrograms. Alternatively, the arithmetic unit 112 may obtain a reference spectrogram by smoothing the first time spectrogram in the time direction, and obtain first to m-th difference spectrograms by subtracting the reference spectrogram from the first to m-th time spectrograms. m is an integer of one or more. The output unit 114 may output presentation information based on the first to m-th difference spectrograms.

The acquisition unit 111 may acquire vibration information of three or more channels. The arithmetic unit 112 may calculate a cross-power spectrogram or the like from vibration information of any two of the three channels.

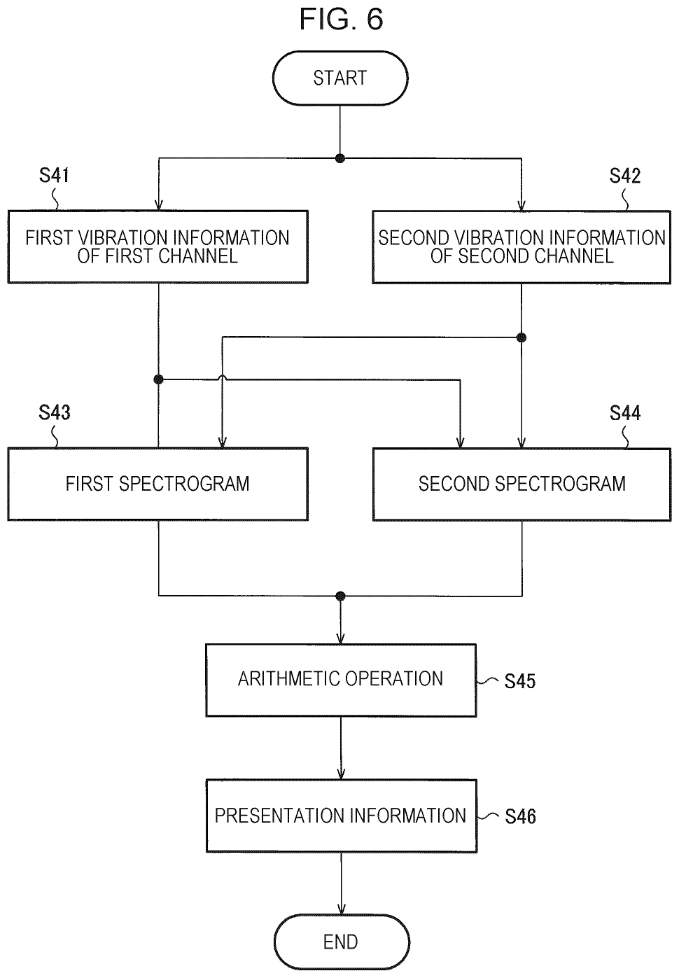

FIG. 6 illustrates a second processing flow example executed by the processing unit. In steps S41 and S42, the acquisition unit 111 acquires first vibration information of the first channel and second vibration information of the second channel from the sensor 140.

In step S43, the arithmetic unit 112 calculates a first type of spectrogram from the first vibration information and the second vibration information, among a cross-power spectrogram, a cross-phase spectrogram, and a coherence spectrogram. This is referred to as a first spectrogram.

In step S44, the arithmetic unit 112 calculates a second type of spectrogram different from the first type, among a cross-power spectrogram, a cross-phase spectrogram, and a coherence spectrogram, from the first vibration information and the second vibration information. This is referred to as a second spectrogram.

In step S45, the arithmetic unit 112 performs an arithmetic operation on the first spectrogram and the second spectrogram. The arithmetic operation is addition, subtraction, multiplication, division, or a combination thereof, of the first spectrogram and the second spectrogram at the same time. The arithmetic unit 112 performs the arithmetic operation on a spectrogram before conversion using a color map, for example. That is, the arithmetic unit 112 performs the above arithmetic operation on a spectrogram value corresponding to a pixel of the first spectrogram and a spectrogram value corresponding to a pixel of the second spectrogram at the same position, and executes the operation for each pixel. The arithmetic unit 112 may perform the arithmetic operation on a spectrogram after conversion using the color map.

In step S46, the output unit 114 analyzes the spectrogram after the arithmetic operation outputted by the arithmetic unit 112, and outputs presentation information to the presentation unit 150 based on the result.

The acquisition unit 111 may acquire vibration information of three or more channels. The arithmetic unit 112 may calculate the first spectrogram and the second spectrogram from vibration information of any two of the three channels.

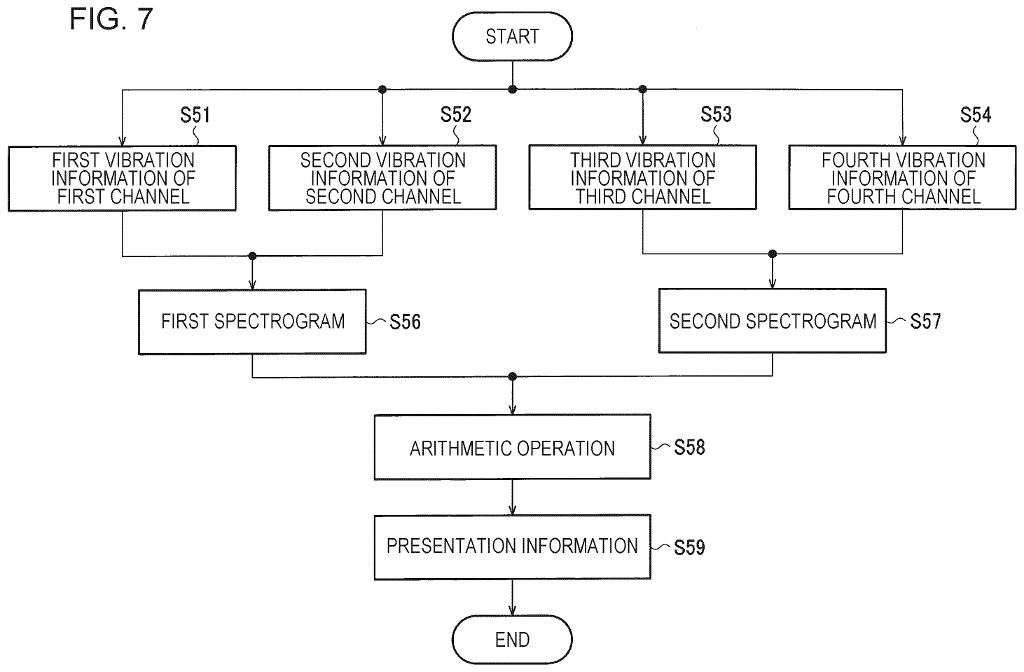

FIG. 7 illustrates a third processing flow example executed by the processing unit. In steps S51 to S54, the acquisition unit 111 acquires first vibration information of a first channel, second vibration information of a second channel, third vibration information of a third channel, and fourth vibration information of a fourth channel from the sensor 140.

In step S56, the arithmetic unit 112 calculates a first type of spectrogram from the first vibration information and the second vibration information, among a cross-power spectrogram, a cross-phase spectrogram, and a coherence spectrogram. This is referred to as a first spectrogram.

In step S57, the arithmetic unit 112 calculates a spectrogram of the same type as the first type from the third vibration information and the fourth vibration information, among a cross-power spectrogram, a cross-phase spectrogram, and a coherence spectrogram. This is referred to as a second spectrogram.

In step S58, the arithmetic unit 112 performs an arithmetic operation on the first spectrogram and the second spectrogram.

In step S59, the output unit 114 analyzes the spectrogram after the arithmetic operation outputted by the arithmetic unit 112, and outputs presentation information to the presentation unit 150 based on the result.

### 3. Vibration Analysis Example

A specific example of vibration analysis using the above-mentioned method will be described below.

In vibration analysis of the related art, it is assumed that the amplitude or frequency peak changes. There are few detection methods that focus on phase changes. Even if there is one that focuses on phase changes, a one-channel sensor is used as in JP-A-2022-154180 described above.

In this embodiment, a multi-channel sensor is used to acquire vibration time-series data. Then, from the vibration time-series data, not only an amplitude spectrogram but also a cross spectrogram, a cross-phase spectrogram, a coherence spectrogram, or a spectrogram obtained by arithmetic operation thereof is obtained and analyzed. Since the sensor data needs to be synchronized between a plurality of axes or at different measurement points, a sensor with excellent synchronization performance is used. For example, a unitized sensor such as an IMU is used, but the present disclosure is not limited thereto.

The processing system 100 of this embodiment uses multi-channel vibration data, for example, multi-channel vibration data with different orientations at the same position of the object. The processing system 100 calculates a spectrogram for at least one of amplitude, power, cross, cross-phase, and coherence from the vibration data. The processing system 100 uses the coherence of the vibration data to weight information. The processing system 100 uses the spectrogram for condition monitoring, quality control or predictive maintenance of the object. The processing system 100 uses, as an index, statistical information such as an average value or variance value obtained from the spectrogram, or changes in cross-phase or coherence in a specific frequency range. According to this embodiment, since the device vibration is directly used, there is no need to sweep the vibration frequency, making it possible to capture even slight changes in mass, spring coefficient, or damper coefficient of the object without missing anything.

The processing system 100 of this embodiment may also use a spectrogram obtained by arithmetically operating two or more spectrograms obtained at different positions of the object, among the spectrograms for amplitude, cross, cross-phase, and coherence. The data can thus be compared, even if not synchronized with each other, in measurement at different positions.

The processing system 100 of this embodiment may also use multi-channel vibration data with different orientations at the same position of the object. This makes it possible to capture a change in the vibration direction or in phase relationship between the orientations as a clear change, even if the vibration strength does not change.

Furthermore, the processing system 100 of this embodiment may detect the vibration state using the average value or variance value of the spectrogram as an index. This makes it possible to detect slight changes in state with high accuracy.

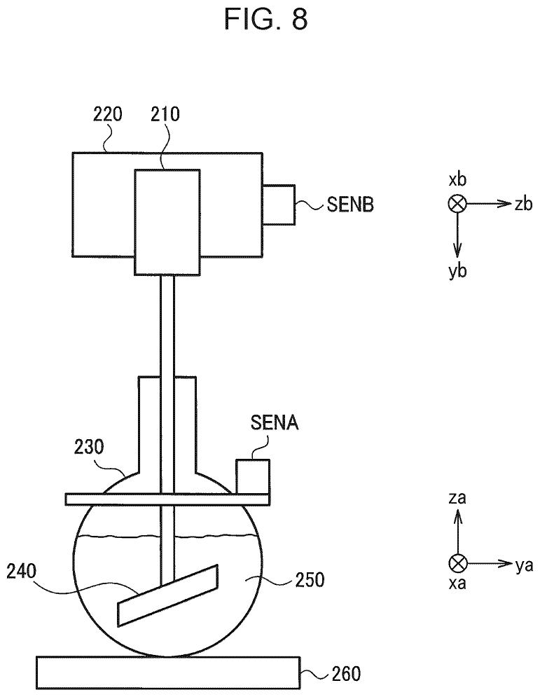

An example of vibration analysis will be described below. FIG. 8 illustrates a configuration example of an experimental apparatus. A flask 230 containing glycerin 250 is placed on a hot plate 260, and the glycerin 250 is heated by the hot plate 260. A stirring rod is attached to a motor 210. A blade 240 of the stirring rod is inserted into the glycerin 250 to stir the glycerin 250 by the rotation of the motor 210. A controller 220 is attached to the motor 210 to control the rotation of the motor 210.

A first vibration sensor SENA is attached to the wall of the flask 230, and a second vibration sensor SENB is attached to the wall of the controller 220. Each vibration sensor is a three-axis speed sensor. xa, ya, and za are detection axes of the first vibration sensor SENA, which correspond to x-axis, y-axis, and z-axis, respectively, and are orthogonal to each other. xb, yb, and zb are detection axes of the second vibration sensor SENB, which correspond to the x-axis, y-axis, and z-axis, respectively, and are orthogonal to each other.

The viscosity of the glycerin 250 changes with temperature. It is known that the viscosity is about 100 mPa·s at 40 degrees Celsius, and about 10 mPa·s at 70 degrees Celsius.

The measurement procedure is as follows. First, the stirring rod is inserted into the flask 230. 200 ml of glycerin is poured into the flask 230. The flask 230 is a separable flask, and its upper and lower parts are joined and fixed with a fastening clamp. The motor 210, which is a stirring device main body, and the like are set on the flask 230, and the flask 230 is placed on the hot plate 260. The first vibration sensor SENA and the second vibration sensor SENB are fixed to the apparatus with a double-sided tape.

The hot plate 260 is set to 40 degrees Celsius, and the glycerin 250 is heated by the hot plate 260. Then, stirring is started at a stirring speed of 256 rpm. The temperature of the hot plate 260 is gradually increased to 70 degrees Celsius over one hour, and vibration caused by the stirring during the temperature increase is measured by the first vibration sensor SENA and the second vibration sensor SENB. The stirring device is temporarily stopped after 45 minutes to measure the temperature midway. The stirring speed when the stirring is resumed is 250 rpm, which is slightly slower than before the stop.

It is also confirmed by visual observation of the liquid level during stirring that the viscosity of the glycerin 250 clearly decreases as the temperature increases.

The first vibration sensor SENA and the second vibration sensor SENB are three-axis digital output quartz vibration sensors with a vibration band of 10 to 1000 Hz. The vibration sensors are fixed using a double-sided tape confirmed to have no influence on the measurement band. A measurement sampling rate is 3000 samples per second.

It is known that, in a forced vibration frequency response model of a degree-of-freedom viscous damping system, the vibration amplitude or phase changes as an elastic coefficient or damper coefficient changes. It is expected that changes in viscoelasticity can be detected by sensing the vibration as a response to the forced vibration caused by the stirring device and checking the change over time in the relative phase in the time-series data. It is difficult to measure the absolute phase of the vibration, but it is possible to measure the change in the relative phase between two pieces of vibration data. The relative phase is considered to contain information corresponding to the state of the rotating equipment, and the relative phase itself can be an index representing the state of the analysis object. However, the object to which the vibration analysis method of this embodiment can be applied is not limited to such a degree-of-freedom viscous damping system, and may be an apparatus composed only of solids, for example.

Examples of spectrograms obtained by the apparatus illustrated in FIG. 8 will be described below. Since vibration energy is concentrated in a relatively low frequency band, spectrograms in the frequency range of 0 to 200 Hz are illustrated.

FIGS. 9 to 11 illustrate examples of spectrograms obtained from vibration data outputted by the first vibration sensor. “x-y axis” represents that a relative phase and the like between x-axis vibration data and y-axis vibration data are used. The same applies to “y-z axis” and “z-x axis”.

An amplitude spectrogram is obtained by using a rectangular window function with a width of 4 seconds and shifting the window function in the time direction while overlapping it by 2 seconds. A relative phase spectrogram is a plot of a phase difference between target channels as a relative phase, for a phase of a complex number during calculation of the amplitude spectrogram. A coherence spectrogram is obtained by preparing two channels of time-series data with a width of 4 seconds cut out with a rectangular window function, calculating coherence, and repeating this with a 2-second overlap of the window function. A color map is illustrated to the right of each spectrogram. The amplitude is in decibels. A cross-phase is expressed as a numerical value from −π to +π radians. The coherence is a numerical value in the range from 0 to 1.

FIGS. 9 to 11 illustrate spectrograms calculated from 5-minute time-series data cut out from the vibration data from the first vibration sensor SENA. By comparing the amplitude spectrogram and the cross-phase spectrogram with the coherence spectrogram, it is possible to get an idea of which vibration frequency component has a high correlation.

A frequency where the coherence spectrogram is dark means that the correlation between channels is low at that frequency. A frequency where the coherence spectrogram is bright means that the correlation between channels is high at that frequency. For example, the correlation between channels is low at 150 to 200 Hz. At frequencies where the correlation between channels is low, the relative phase relationship between the vibration components is not stable. This causes the cross-phase spectrogram to have random values, making the colors random. When the vibration pattern changes, the color or distribution of the spectrogram changes. Since the stripes along the horizontal axis are stable, it can be seen in this specific example that the vibration is steady for about 5 minutes.

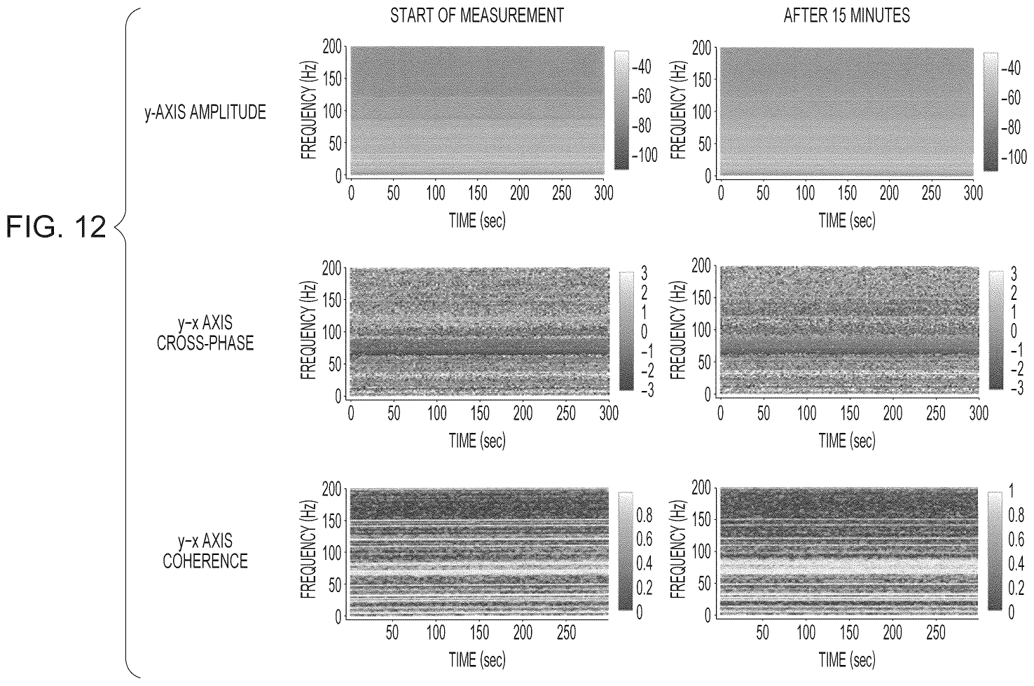

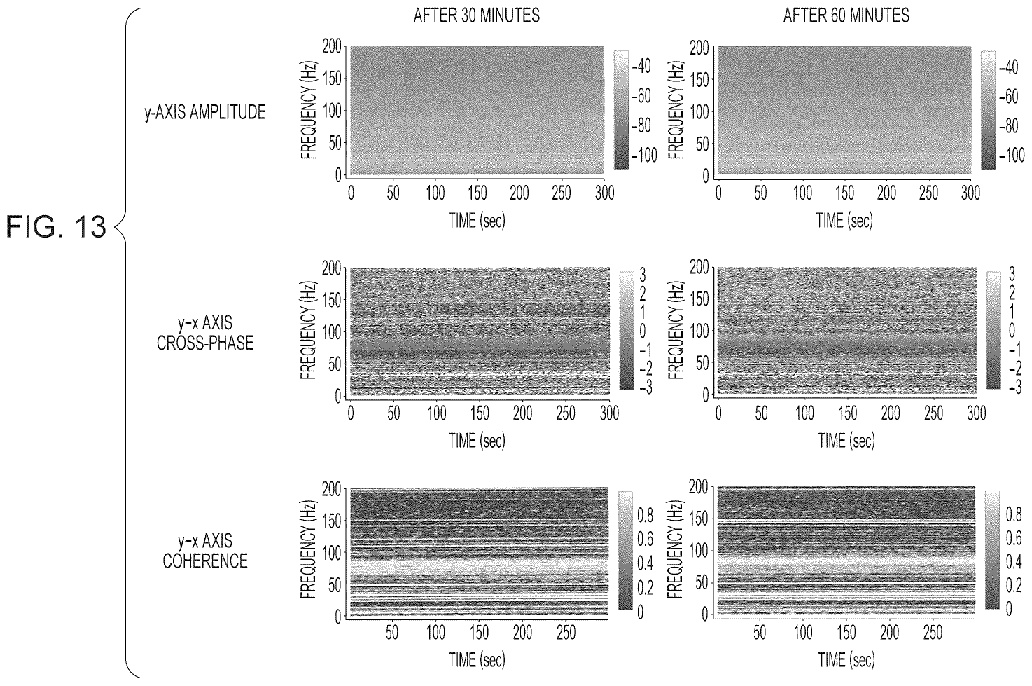

FIGS. 12 and 13 illustrate spectrograms of the first vibration sensor immediately after, 15 minutes after, 30 minutes after, and 60 minutes after the start of measurement. Here, a y-axis amplitude spectrogram, a y-x cross-phase spectrogram, and a y-x coherence spectrogram are illustrated. The same observations as below can be made for the x-axis and z-axis.

After 15 minutes: A slight change in peak intensity distribution can be confirmed in the amplitude spectrogram. Changes are clearly captured in the relative phase spectrogram and the coherence spectrogram. For example, the stripes at 100 to 150 Hz have changed in the cross-phase spectrogram. In the coherence spectrogram, the bright stripes around 75 Hz have changed to thicker, brighter stripes.

After 30 minutes: The intensity value appears to have increased as a whole in the amplitude spectrogram. Since there is no change in appearance of the cross-phase spectrogram and the coherence spectrogram, it can be seen that there is little change from the perspective of viscoelasticity.

After 60 minutes: Clear changes can be observed in each of the amplitude spectrogram, cross-phase spectrogram, and coherence spectrogram. For example, the frequency or density of the striped pattern has changed in the cross-phase spectrogram and the coherence spectrogram. This indicates that the viscosity of the glycerin 250 has decreased and the vibration pattern has changed.

As described above, it can be seen that the cross-phase spectrogram and the coherence spectrogram have larger changes as a whole than the amplitude spectrogram, and have high sensitivity for changes in vibration state. Furthermore, there are changes in the amplitude spectrogram after 60 minutes, for example, showing that the sensitivity is further improved by combining the amplitude spectrogram.

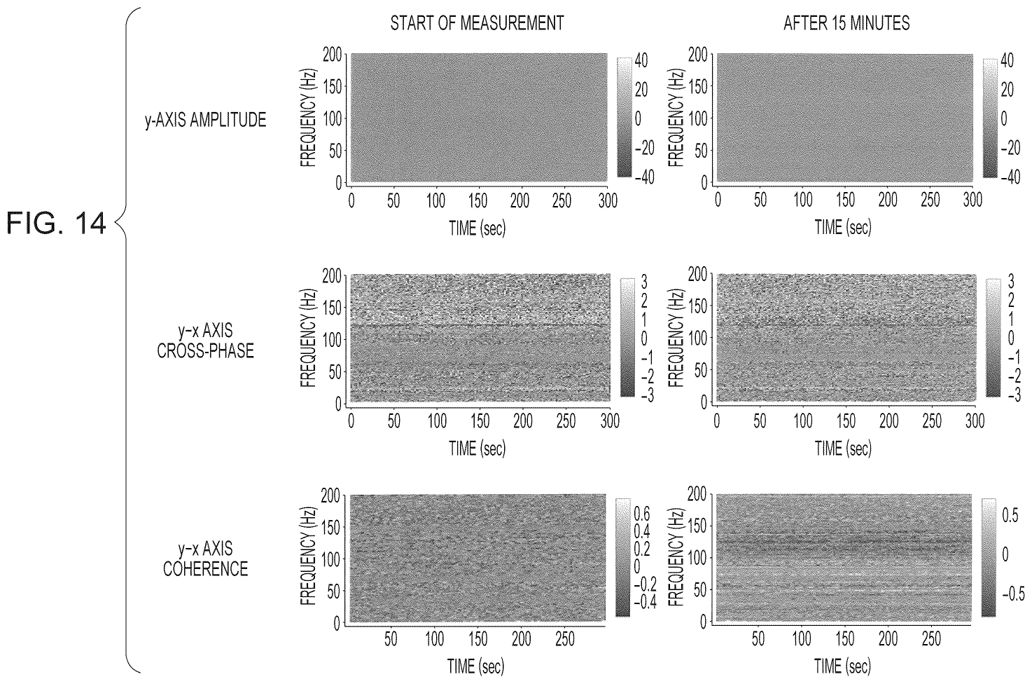

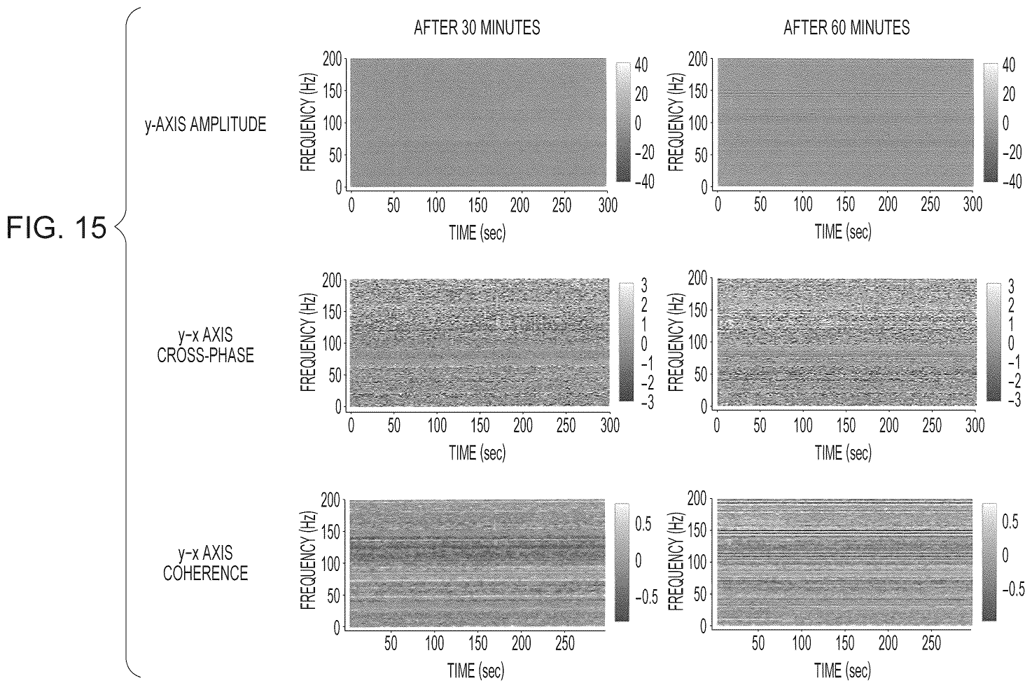

FIGS. 14 and 15 illustrate a differences between a reference spectrogram and the spectrograms of the first vibration sensor immediately after, 15 minutes after, 30 minutes after, and 60 minutes after the start of measurement.

The reference spectrogram of the amplitude spectrogram is obtained by averaging the amplitude spectrogram in the time axis direction immediately after the start of measurement. The same applies to the reference spectrogram of the cross-phase spectrogram and the reference spectrogram of the coherence spectrogram. Subtracting the reference spectrogram from the spectrogram at each time makes it easier to capture changes from the reference spectrogram.

Immediately after start of measurement: With the reference spectrogram subtracted, the values are close to 0 in the stable band. Fluctuations in values result in a distribution with the average value of 0, giving a rough appearance. The larger the fluctuations, the darker the color.

After 15 minutes: A slight increase in peak intensity distribution can be observed in the amplitude spectrogram. Changes in vibration state are captured in the cross-phase spectrogram and the coherence spectrogram capture. Particularly, the coherence spectrogram shows large changes.

After 30 minutes: An overall increase in the amplitude spectrogram intensity can be observed. There is no change in appearance of the cross-phase spectrogram. The shading of the coherence spectrogram has changed. Specifically, in the coherence spectrogram, the vibration with low correlation has even lower correlation, and the vibration with high correlation has even higher correlation. There is little change from the perspective of viscoelasticity.

After 60 minutes: A clear change can be seen in each of the three spectrograms. However, this change is also due to a slight change in the stirring speed, and a frequency shift is also highlighted. From the perspective of capturing a change caused by the decrease in viscosity, it is desirable to be able to distinguish this change from the change caused by a slight change in the stirring speed.

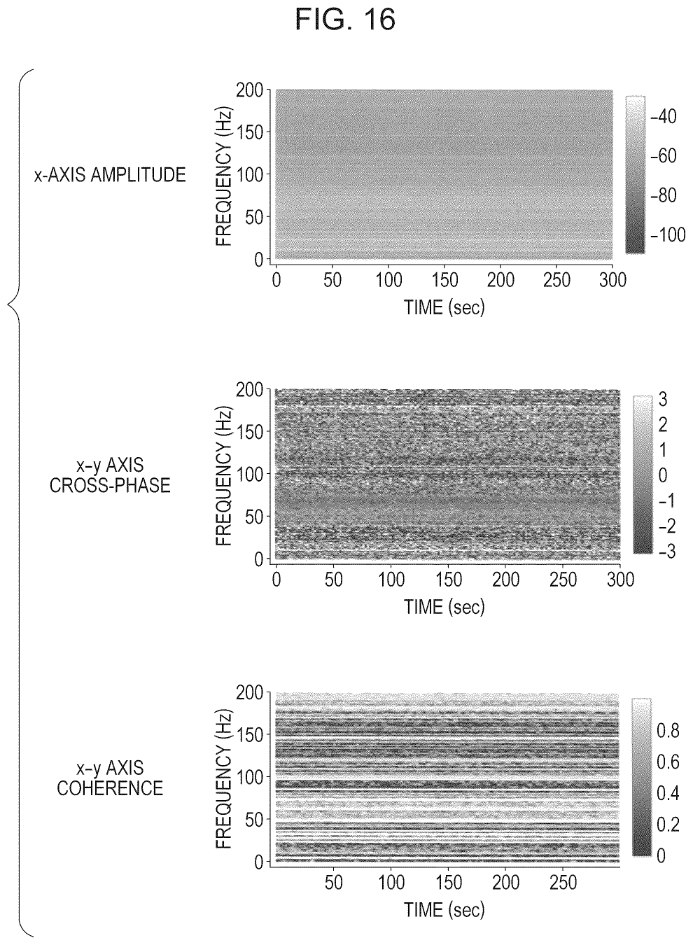

FIGS. 16 to 18 illustrate examples of spectrograms obtained from the vibration data outputted by the second vibration sensor. The method of creating each spectrogram is the same as in FIGS. 9 to 11. The first vibration sensor SENA and the second vibration sensor SENB are attached in different positions. Comparing the spectrograms in FIGS. 16 to 18 and the spectrograms in FIGS. 9 to 11, it can be seen that the vibration patterns differ due to the difference in measurement position.

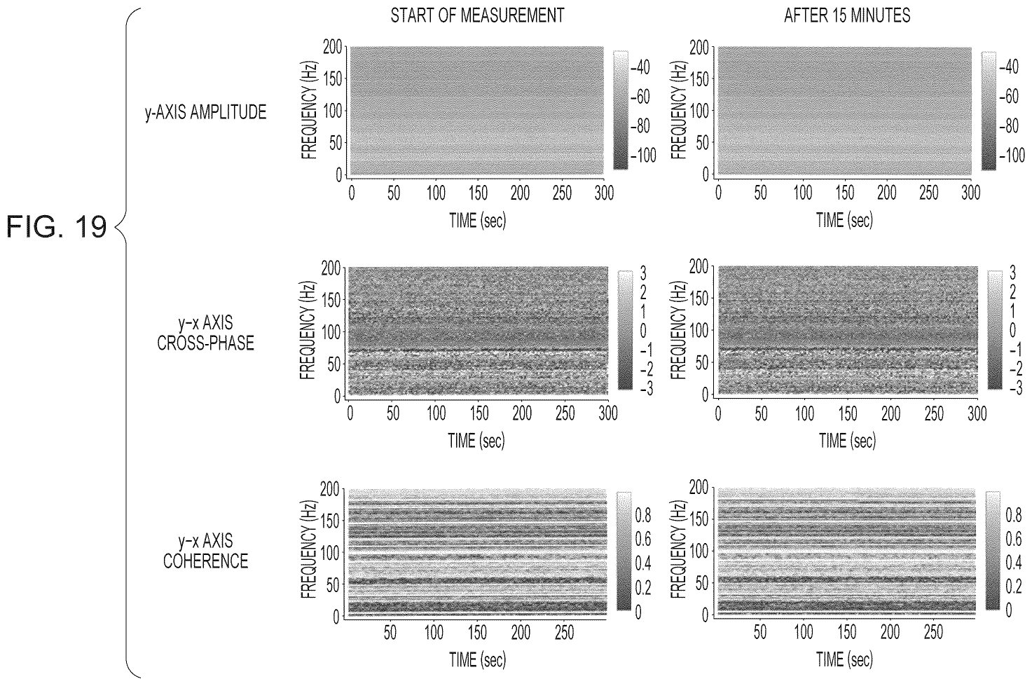

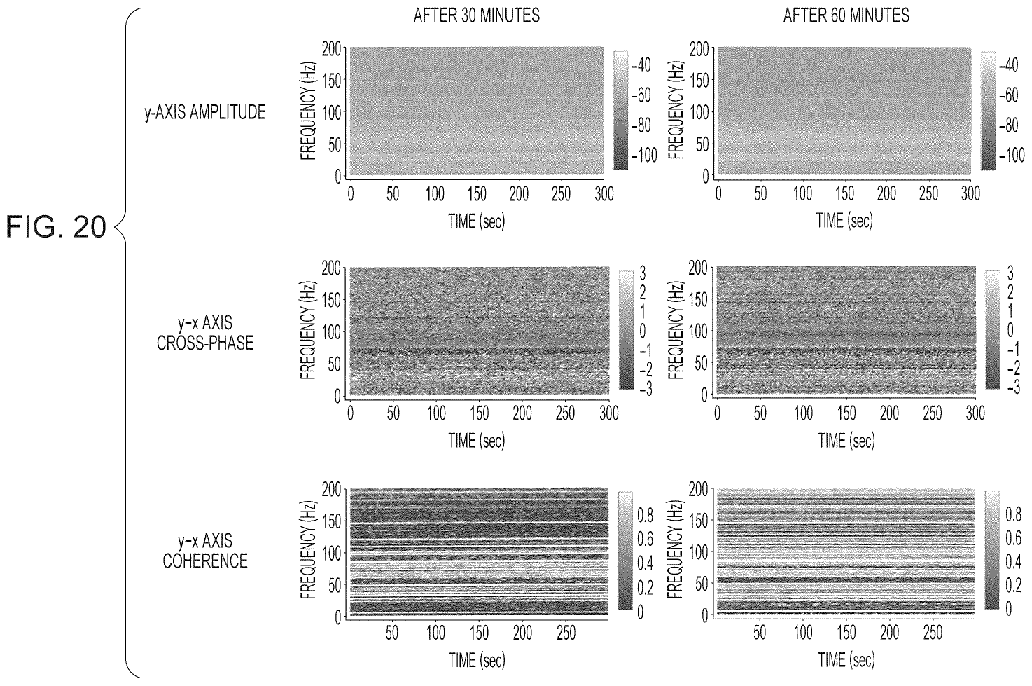

FIGS. 19 and 20 illustrate spectrograms of the second vibration sensor immediately after, 15 minutes after, 30 minutes after, and 60 minutes after the start of measurement. Here, a y-axis amplitude spectrogram, a y-x axis cross-phase spectrogram, and a y-x coherence spectrogram are illustrated. The same observations as below can be made for the x-axis and z-axis.

After 15 minutes: The three spectrograms appear to have not significantly changed since immediately after the start of measurement.

After 30 minutes: The intensity values in the amplitude spectrogram appear to have increased as a whole. Changes in vibration state are clearly captured in the cross-phase spectrogram and the coherence spectrogram.

After 60 minutes: With the decreased viscosity, clear changes can be observed in each of the three spectrograms.

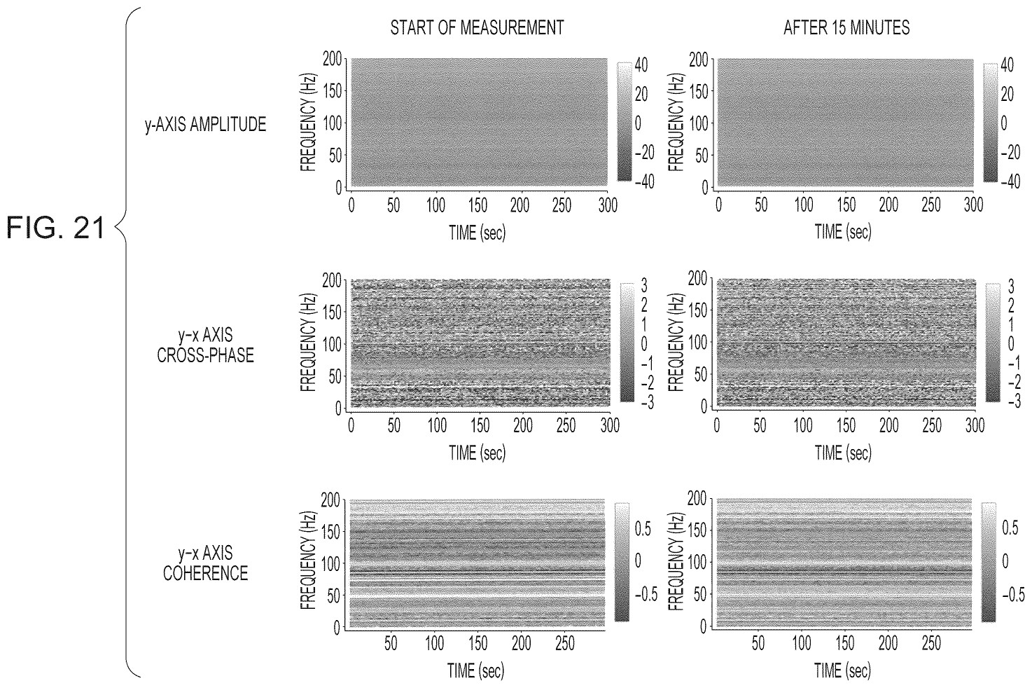

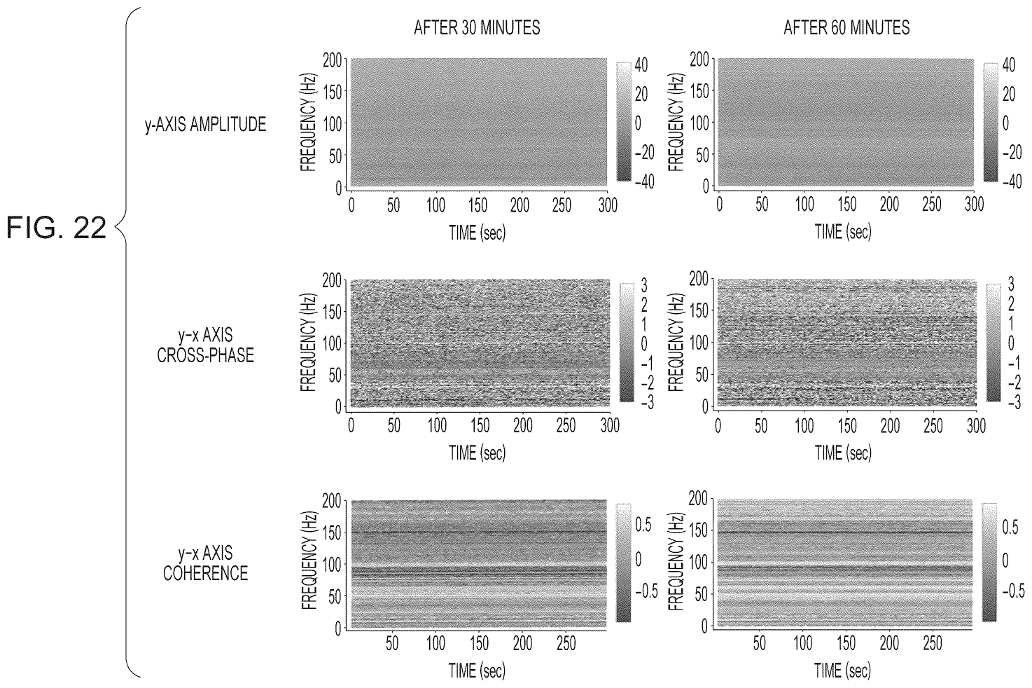

FIGS. 21 and 22 illustrate differences between the spectrogram of the first vibration sensor and the spectrogram of the second vibration sensor immediately after, 15 minutes after, 30 minutes after, and 60 minutes after the start of measurement. Immediately after, 15 minutes after, 30 minutes after, and 60 minutes after the start of measurement, the spectrograms of the first vibration sensor are averaged in the time axis direction, and the difference between the average spectrogram and the spectrogram of the second vibration sensor is illustrated.

Immediately after the start of measurement: In each spectrogram, the values are close to 0 in the stable band. Fluctuations in values result in a distribution with the average value of 0, giving a rough appearance. The larger the fluctuations, the darker the color.

After 15 minutes: The three spectrograms appear to have not significantly changed since immediately after the start of measurement. In the coherence spectrogram, however, changes can be observed in the region below 70 Hz.

After 30 minutes: The intensity value has increased as a whole in the amplitude spectrogram. Changes in vibration state are clearly captured in the cross-phase spectrogram and the coherence spectrogram.

After 60 minutes: With the decreased viscosity, clear changes can be observed in each of the three spectrograms. 45 minutes after the start of measurement, the rotation frequency of the stirring device changes from 256 rpm to 250 rpm. The influence of the rotation frequency of the stirring device can be canceled by the difference between the spectrograms of the two vibration sensors. This makes it possible to distinguish the change due to the decrease in viscosity from the change due to a slight change in the stirring speed, leading to more accurate detection of the vibration state.

In the above example, the average value of the spectrograms is obtained in the time axis direction for each frequency and used as the reference spectrum. However, the method of creating the reference spectrogram is not limited thereto. For example, instead of obtaining the average value, the difference between the spectrograms of the vibration sensors may be calculated using an arbitrary spectrogram itself as the reference.

4. Example of Method of Creating Presentation Information from Spectrogram

The output unit 114 extracts characteristic frequencies from the entire spectrogram. The characteristic frequency is, for example, a peak frequency or a frequency with a stable intensity distribution. The output unit 114 displays changes in target information amount at the extracted frequency as a function of time in a graph or the like. The target information amount is an intensity value, a relative phase or the like. The function may be anything that shows changes over time, and may be a formula, time-series data on the target information amount, or the like. The output unit 114 uses the function to obtain statistics of the target information amount in a steady state. The statistics are the average value or variance of the function, and the like. The output unit 114 sets a threshold for the statistics, and causes the presentation unit 150 to output a warning when the statistics exceed the threshold.

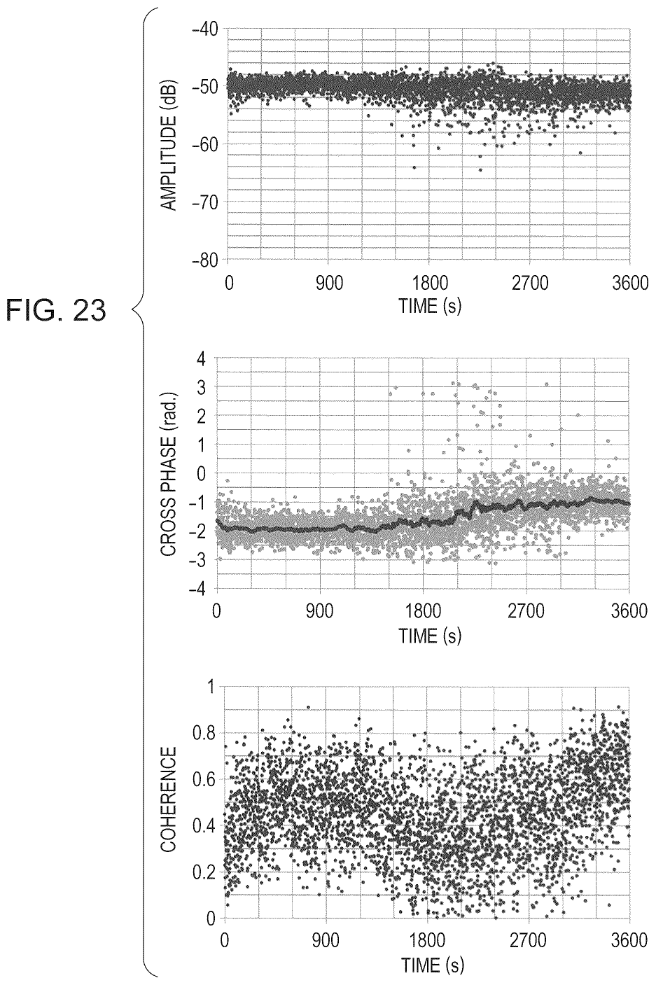

FIG. 23 illustrates a first example of the presentation information. For the change in viscosity of the glycerin due to a rise in temperature, the vibration caused during stirring is measured to obtain an amplitude spectrogram, a cross-phase spectrogram, and a coherence spectrogram.

With focus on 60.5 Hz as a characteristic frequency, the upper part of FIG. 23 illustrates a time-series plot of the amplitude values at 60.5 Hz in the y-axis vibration data. The middle part of FIG. 23 illustrates a time-series plot of the cross-phase at 60.5 Hz in the y-axis and z-axis vibration data. As for the cross-phase plot, a 60-second moving average is plotted with dark black dots for ease of viewing. The lower part of FIG. 23 illustrates a time-series plot of the coherence at 60.5 Hz in the y-axis and z-axis vibration data.

Although no clear change over time can be observed from the amplitude plot and the coherence plot, a phase change that is correlated with the viscosity change can be extracted from the cross-phase plot. This can be used as an index for quality control in material manufacturing process, for example.

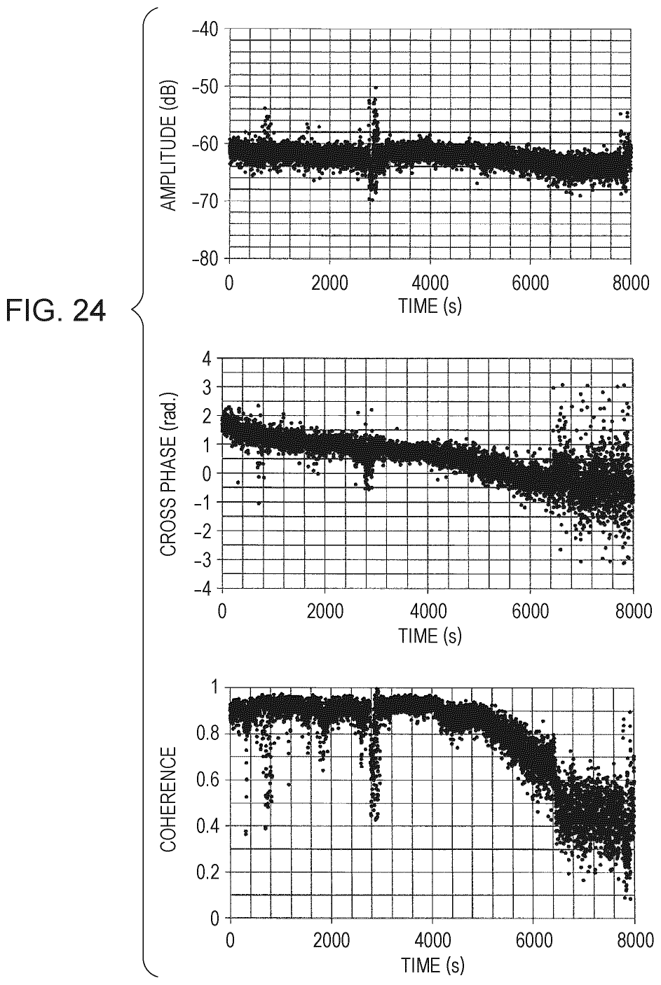

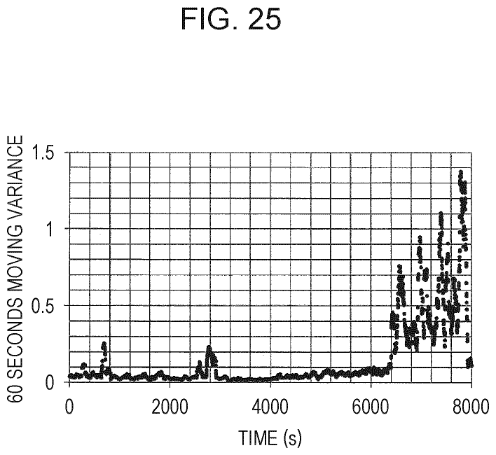

FIGS. 24 and 25 illustrate a second example of the presentation information. In measurement different from that illustrated in FIG. 23, a change in viscosity of glycerin is measured by increasing the temperature to 80 degrees Celsius. As for the change in viscosity of glycerin due to temperature rise, the vibration caused during stirring is measured to obtain an amplitude spectrogram, a cross-phase spectrogram, and a coherence spectrogram.

With focus on 108.5 Hz, which is one of the peaks in the amplitude spectrum, as a characteristic frequency, the upper part of FIG. 24 illustrates a time-series plot of the amplitude values at 108.5 Hz in the z-axis vibration data. The middle part of FIG. 24 illustrates a time-series plot of the cross-phase at 108.5 Hz in the z-axis and x-axis vibration data. The lower part of FIG. 24 illustrates a time-series plot of the coherence at 108.5 Hz in the z-axis and x-axis vibration data. Note that the occasional jumps in values at 700 seconds, 1600 seconds, 2800 seconds, and the like are vibration noise associated with the operation of the equipment.

FIG. 25 illustrates time-series changes in variance in the cross-phase plot. A 60-second rectangular window function is used to extract a value from the cross-phase plot, and the variance of the extracted value is calculated. The variance is calculated one after another while shifting the start point of the rectangular window function by 1 second each time, and the time-series data is plotted.

In the second example, the values from 107.0 Hz to 110.0 Hz, centered on 108.5 Hz, are added up for each time period, and the average value is used. This makes it possible to mitigate the influence of vibration fluctuations, that is, peak fluctuations.

As shown in the middle part of FIG. 24, as for the change in viscosity due to temperature rise, the cross-phase changes as the viscosity decreases.

As shown in FIG. 25, the cross-phase variance is below 0.1 in the steady state. The noise associated with equipment operation does not exceed 0.3. For these reasons, 0.4 is set as a threshold value, and it is determined that there is an abnormality when this threshold value is exceeded.

As shown in FIG. 25, a change that seems to be some kind of phase transition occurs at the time point of 6400 seconds, and the cross-phase variance exceeds the threshold value of 0.4. Therefore, the system detects an abnormal state and outputs an alarm. An operator notices the alarm and ends the experiment 30 minutes later.

Note that the method of detecting system abnormalities is not limited to the above. For example, the time until a system abnormality occurs may be estimated by calculating a coherence moving average and predicting the time when the coherence falls below 0.5 from the slope.

As shown in FIG. 24, since no clear signs of change in viscosity appear in the amplitude plot, it is difficult to detect the signs of change in viscosity from the amplitude plot. On the other hand, clear signs of change in viscosity appear in the cross-phase plot and the coherence plot. Therefore, these plots can be used to improve the sensitivity of detecting the signs of change in viscosity.

The processing system 100 of this embodiment described above includes the acquisition unit 111, the arithmetic unit 112, and the output unit 114. The acquisition unit 111 acquires first vibration information of a first channel and second vibration information of a second channel about vibration of an object. The arithmetic unit 112 calculates a spectrogram including at least one of a cross-power spectrogram, a cross-phase spectrogram, and a coherence spectrogram of the first vibration information and the second vibration information. The output unit 114 outputs presentation information on at least one of condition monitoring, quality control, and predictive maintenance of the object, based on the spectrogram.

According to this embodiment, condition monitoring, quality control or predictive maintenance of the object can be performed based on vibration analysis using vibration information of a plurality of channels. Even if a change in vibration state is so minute that it cannot be easily seen in an amplitude spectrogram of one channel, such a minute change in vibration state can be detected by using a relative spectrogram of the plurality of channels. For example, even if the change in intensity value of the amplitude spectrogram is small, there may be a change in the cross-phase or coherence between the plurality of channels. By using these spectrograms, the detection sensitivity for the vibration state can be improved.

In this embodiment, the first vibration information may be vibration information on the first axis detected by the first vibration sensor. The second vibration information may be vibration information on the second axis detected by the first vibration sensor.

For example, in FIG. 9, the first vibration information is vibration information on the x-axis detected by the first vibration sensor SENA, and the second vibration information is vibration information on the y-axis detected by the first vibration sensor SENA.

According to this embodiment, a spectrogram including at least one of a cross-power spectrogram, a cross-phase spectrogram, and a coherence spectrogram can be calculated from the vibration information on the first axis and the vibration information on the second axis at the same position of the object. A change in the vibration state can thus be detected by evaluating the correlation of vibration between the plurality of axes at the same position. For example, the correlation of phase changes between linear vibration and elliptic vibration, or between a stationary state and a rotating state of the axis of elliptic vibration, and a change occurs in each spectrogram. By detecting such changes, minute changes in the vibration state can be detected.

Furthermore, in this embodiment, the first vibration information may be vibration information on the first axis detected by the first vibration sensor. The second vibration information may be vibration information on the first axis or the second axis detected by the second vibration sensor disposed at a position different from that of the first vibration sensor.

According to this embodiment, a spectrogram including at least one of a cross-power spectrogram, a cross-phase spectrogram, and a coherence spectrogram can be calculated from the vibration information on the first axis and the vibration information on the first axis or the second axis at different positions of the object. A path along which the vibration travels from the vibration source to the first vibration sensor is different from a path along which the vibration travels from the vibration source to the second vibration sensor. By evaluating the correlation between the vibrations at different positions, a change in the vibration state can be detected.

In this embodiment, the first vibration information may be a first physical quantity that is acceleration, velocity, displacement, angular acceleration, angular velocity, or angle of the first axis among the x-axis, y-axis, and z-axis. The second vibration information may be a first physical quantity of the second axis different from the first axis among the x-axis, y-axis, and z-axis.

For example, in FIG. 9, the first physical quantity is velocity, the first vibration information is velocity on the x-axis, and the second vibration information is velocity on the y-axis.

In this embodiment, the first vibration information may be a first physical quantity that is acceleration, velocity, displacement, angular acceleration, angular velocity, or angle of the first axis among the x-axis, y-axis, and z-axis. The second vibration information may be a second physical quantity different from the first physical quantity, among the acceleration, velocity, displacement, angular acceleration, angular velocity, and angle of the first axis.

When the object vibrates, the acceleration, velocity, displacement, angular acceleration, angular velocity, or angle changes. Specifically, a spectrogram can be created from these physical quantities and the vibration state can be estimated by analyzing the spectrogram.

In this embodiment, the output unit 114 may output presentation information based on statistical information on the spectrogram.

When the vibration state changes, the statistical information on the spectrogram changes. In the example of FIG. 25, the cross-phase variance changes as the viscosity of glycerin changes. This can be used to estimate the vibration state from the statistical information on the spectrogram, and the presentation information about the vibration state can be outputted.

In this embodiment, the output unit 114 may output the presentation information based on a change in the spectrogram over time at a specific frequency or within a specific frequency range.

In the example of FIG. 23, the specific frequency is 60.5 Hz. In the example of FIGS. 24 and 25, the specific frequency range is from 107.0 Hz to 110.0 Hz, centered on 108.5 Hz.

According to this embodiment, there is a specific frequency or a specific frequency range in which the influence of a change in vibration state is likely to appear in the spectrogram. By analyzing changes in the spectrogram over time at that specific frequency or within the specific frequency range, a vibration state can be estimated, and presentation information about the vibration state can be outputted.

In this embodiment, the arithmetic unit 112 may obtain a reference spectrogram by smoothing the spectrogram in the time direction, and obtain a difference spectrogram by subtracting a reference spectrogram from the spectrogram. The output unit 114 may output the presentation information based on the difference spectrogram.

In the example of FIGS. 14 and 15, the reference spectrogram is obtained by smoothing each spectrogram immediately after the start of measurement in the time direction. A difference spectrogram is obtained by subtracting the reference spectrogram from each spectrogram immediately after, 15 minutes after, 30 minutes after, and 60 minutes after the start of measurement.

By obtaining a difference from the reference spectrogram, an unchanged portion from the reference spectrogram is canceled, and thus changes from the reference spectrogram are highlighted. The use of such a difference spectrogram improves the sensitivity of detecting changes in vibration state.

Moreover, according to this embodiment, the arithmetic unit 112 may perform an arithmetic operation on a first spectrogram of a first type among three types, a cross-power spectrogram, a cross-phase spectrogram, and a coherence spectrogram, of the first vibration information and the second vibration information, and a second spectrogram of a second type different from the first type among the three types. The output unit 114 may output the presentation information based on the result of the arithmetic operation.

Furthermore, according to this embodiment, the acquisition unit 111 may acquire third vibration information of a third channel and fourth vibration information of a fourth channel about the vibration of the object. The arithmetic unit 112 may perform an arithmetic operation on the first spectrogram and the second spectrogram. The first spectrogram is a spectrogram of a first type among three types, a cross-power spectrogram, a cross-phase spectrogram, and a coherence spectrogram, of the first vibration information and the second vibration information. The second spectrogram is a spectrogram of the first type or a second type different from the first type among three types, a cross-power spectrogram, a cross-phase spectrogram, and a coherence spectrogram, of the third vibration information and the fourth vibration information. The output unit 114 may output the presentation information based on the result of the arithmetic operation.

According to this embodiment, by performing an arithmetic operation on two spectrograms, the spectrogram can be processed to make it easier for changes in vibration state to appear. This improves the sensitivity of detecting changes in vibration state. One example of the arithmetic operation is multiplication of a cross-phase spectrogram and a coherence spectrogram. In the coherence spectrogram, a coherence value is small in a low correlation band. When the cross-phase spectrogram is multiplied by the coherence spectrogram, a band portion where the value of the cross-phase spectrogram is random is multiplied by a band portion where the value of the coherence spectrogram is small. This highlights a band where the cross-phase is not random but characteristic in the cross-phase spectrogram. The use of such a highlighted spectrogram improves the sensitivity of detecting changes in vibration state. Note that, as described with reference to FIG. 6 and the like, the target or details of the arithmetic operation may vary.

This embodiment may be implemented as a computer-readable program. The program causes a computer to function as the acquisition unit 111, the arithmetic unit 112, and the output unit 114. The acquisition unit 111 acquires first vibration information of a first channel and second vibration information of a second channel about vibration of an object. The arithmetic unit 112 calculates a spectrogram including at least one of a cross-power spectrogram, a cross-phase spectrogram, and a coherence spectrogram of the first vibration information and the second vibration information. The output unit 114 outputs presentation information on at least one of condition monitoring, quality control, and predictive maintenance of the object, based on the spectrogram.

This embodiment may also be implemented as a processing method. The processing method includes acquiring first vibration information of a first channel and second vibration information of a second channel about vibration of an object. The processing method includes calculating a spectrogram including at least one of a cross-power spectrogram, a cross-phase spectrogram, and a coherence spectrogram of the first vibration information and the second vibration information. The processing method includes outputting presentation information on at least one of condition monitoring, quality control, and predictive maintenance of the object, based on the spectrogram. The processing method causes a computer, for example, to perform these steps.

### 5. Vibration Analysis Example for Condition Monitoring, Quality Control, and Predictive Maintenance

Examples of vibration analysis for condition monitoring, quality control, and predictive maintenance will be described as examples to which the processing system 100 of this embodiment can be applied.

Condition monitoring refers to a technology to continuously or periodically monitor the current operating state or performance of a machine or equipment. The main purpose of condition monitoring is to monitor specific parameters such as vibration, sound, temperature, or pressure, and evaluate the health of the machine or equipment. Systems (a) to (f) below are examples of a system for condition monitoring.
(a) A system for issuing an alarm upon detection of abnormal vibration or temperature rise with a sensor attached to an industrial motor.
(b) A system for monitoring the structural integrity of a building by monitoring vibration in the event of an earthquake or strong wind with vibration sensors installed in various locations of the building.
(c) A system for warning an operator upon detection of abnormal vibration with a vibration sensor installed for monitoring the performance of a gas turbine.
(d) A system for helping early detection of wear or failure with a vibration sensor installed for monitoring the integrity of heavy machinery in a mine or quarry.
(e) A system for issuing an alarm upon detection of abnormal vibration with a vibration sensor installed for monitoring the integrity of each machine in a factory production line.
(f) A system for detecting the occurrence of abnormal wear or damage with a vibration sensor attached to a blade or gearbox of a wind power turbine.

Quality control refers to a process of checking if a product or service meets predetermined quality standards or required specifications. Systems (g) to (k) below are examples of a system for quality control.
(g) A system for automatically excluding a product that does not meet standards by using a camera or sensor on a production line to check the product quality such as dimensions, color, and shape in real time.
(h) A system for checking a vibration pattern with a vibration sensor when a product composed of a plurality of parts is operated after the assembly thereof. When abnormal vibration is detected, assembly failure or defective parts may be suspected.
(i) A system for operating a manufactured motor or generator to measure vibration during operation thereof with a vibration sensor. When vibration exceeding a specific standard is detected, internal imbalance or damage may be suspected.
(j) A system for monitoring the influence of vibration with a vibration sensor by installing a newly manufactured electronic device on a vibration test bench to verify whether the electronic device has a set vibration resistance.
(k) A system for monitoring vibration with a vibration sensor during operation of a new railcar or aircraft to check if it has operation performance as designed. The cause of abnormal vibration, if detected, is identified to improve quality.

Predictive maintenance refers to an approach to collect and analyze operation data or status data of equipment or machinery. The purpose of predictive maintenance is to predict the risk of future failure or performance degradation. Systems (l) to (q) below are examples of a system for predictive maintenance.
(l) A system for predictively scheduling the replacement of a specific part by analyzing sensor data, from a sensor attached to an industrial robot, when the industrial robot is operated and sensor data on failures in the past, and detecting a sign of failure of the part.
(m) A system for monitoring the degree of wear with a sensor attached to a wheel of a railcar and predicting when to replace the wheel based on data indicating excessive wear.
(n) A system for predicting the possibility of future leaks by monitoring the condition of pipes or valves in an oil plant with a sensor.
(o) A system for predicting the risk of failure before parts need to be replaced, by analyzing sensor data during operation of an elevator or escalator.
(p) A system for monitoring the efficiency of industrial cooling equipment or air conditioner based on sensor data and predicting part wear or failure.
(q) A system for collecting and analyzing sensor data during operation of agricultural machinery, and predicting part wear or failure to support scheduling of appropriate maintenance activities.

### 6. Spectrogram Calculation Method

As a first method, various spectrogram calculation methods using Fourier transform will be described. A method for calculating a spectrum from vibration data within a window will be described below. A spectrogram is obtained by acquiring a spectrum in time series while moving the window in the time direction. For example, a short-time Fourier transform (STFT) using a fixed-width window is used.

Formula (1) below represents a power spectrum PWxy(f). t represents time and x(t) represents a signal as vibration information. f represents frequency and X(f) represents the Fourier transform of x(t).

$$\begin{matrix}[ Math . 1 ] & \\ PWx ( f ) = {\vert X ( f ) \vert}^{2} & ( 1 )\end{matrix}$$

Formula (2) below represents a cross-power spectrum CRxy(f). x(t) represents a signal as first vibration information and y(t) represents a signal as second vibration information. X(f) represents the Fourier transform of x(t). Y(f) represents the Fourier transform of y(t). * represents a complex conjugate.

$$\begin{matrix}[ Math . 2 ] & \\ CRxy ( f ) = X ( f ) * Y ( f ) & ( 2 )\end{matrix}$$

Formula (2) above can be rewritten as Formula (3) below. The phase angle θ(f) of CRxy(f) represents a cross-phase spectrum. θ(f) represents a phase difference between signals x(t) and y(t) at frequency f. j represents an imaginary unit.

$$\begin{matrix}[ Math . 3 ] & \\ CRxy ( f ) = \vert CRxy ( f ) \vert {e}^{j θ ( f )} & ( 3 )\end{matrix}$$

Formula (4) below represents a coherence spectrum CHxy(f). < > represents an appropriate smoothing operation, such as averaging in the time direction, frequency direction, or time and frequency directions.

$$\begin{matrix}[ Math . 4 ] & \\ CHxy ( f ) = \frac{{\vert 〈 CRxy ( f ) 〉 \vert}^{2}}{〈 {\vert X ( f ) \vert}^{2} 〉 〈 {\vert Y ( f ) \vert}^{2} 〉} & ( 4 )\end{matrix}$$

As a second method, a method of calculating various spectrograms using wavelet transform will be described.

Formula (5) below represents a wavelet transform of the signal x(t). Wx(a,b) represents the wavelet transform of the signal x(t) at scale a and time b. Ψ(t) represents a Morlet wavelet function. Ψ* represents a complex conjugate of the wavelet function. a represents a scale parameter or dilation parameter, which controls the expansion and contraction of the wavelet and corresponds to frequency. b represents a position parameter or transformation parameter of the transformation, which controls the position of the wavelet and corresponds to time.

$$\begin{matrix}[ Math . 5 ] & \\ Wx ( a , b ) = \frac{1}{\sqrt{a}} \int x ( t ) Ψ * ( \frac{t - b}{a} ) dt & ( 5 )\end{matrix}$$

Formula (6) below represents a Morlet wavelet function Ψ(t). ω0 specifies a center frequency. ω0=6 as an example, but the present disclosure is not limited thereto. Various functions such as a Haar wavelet function or a Daubechies wavelet function may be used as the wavelet function.

$$\begin{matrix}[ Math . 6 ] & \\ Ψ ( t ) = {e}^{j ω 0 t} {e}^{- {t}^{2} / 2} & ( 6 )\end{matrix}$$

Formula (7) below represents an arithmetic expression for a wavelet power spectrogram WPWx(a,b), which corresponds to the “power spectrogram”.

$$\begin{matrix}[ Math . 7 ] & \\ WPWx ( a , b ) = {\vert Wx ( a , b ) \vert}^{2} & ( 7 )\end{matrix}$$

Formula (8) below represents an arithmetic expression for a cross wavelet spectrum WCRxy(a,b), which corresponds to the “cross-power spectrogram”. Wy(a,b) represents the wavelet transform of the signal y(t) at scale a and time b.

$$\begin{matrix}[ Math . 8 ] & \\ WCRxy ( a , b ) = Wx ( a , b ) * Wy ( a , b ) & ( 8 )\end{matrix}$$

Formula (8) above can be rewritten as Formula (9) below. The phase angle θ(a,b) of WCRxy(a,b) represents the cross-phase spectrum. θ(a,b) represents a phase difference between the signals x(t) and y(t) at scale a and time b.

$$\begin{matrix}[ Math . 9 ] & \\ WCRxy ( a , b ) = \vert WCRxy ( a , b ) \vert {e}^{j θ ( a , b )} & ( 9 )\end{matrix}$$

Formula (10) below represents an arithmetic expression for a wavelet coherence spectrogram WCH(a,b), which corresponds to the “coherence spectrogram”.

$$\begin{matrix}[ Math . 10 ] & \\ WCH ( a , b ) = \frac{{\vert 〈 {a}^{- 1} WCRxy ( a , b ) 〉 \vert}^{2}}{〈 {a}^{- 1} {\vert Wx ( a , b ) \vert}^{2} 〉 〈 {a}^{- 1} {\vert Wy ( a , b ) \vert}^{2} 〉} & ( 10 )\end{matrix}$$

Although the embodiment has been described in detail above, it will be readily understood by those skilled in the art that many modifications can be made without substantially departing from the novel matters and effects of the present disclosure. Therefore, all such modifications are included in the scope of the present disclosure. For example, a term described at least once together with a different term having a broader meaning or the same meaning in the specification or the drawings may be replaced with the different term in any place in the specification or the drawings. In addition, all combinations of the embodiment and modifications are also included in the scope of the present disclosure. The configurations and operations of the processing unit, storage unit, learned model, sensor, processing system, object, vibration information, spectrogram, and the like are not limited to those described in the embodiment, and various modifications can be made.

What is claimed is:

1. A processing system comprising:
an acquisition unit that acquires first vibration information of a first channel and second vibration information of a second channel about vibration of an object;
an arithmetic unit that calculates a spectrogram including at least one of a cross-power spectrogram, a cross-phase spectrogram, and a coherence spectrogram of the first vibration information and the second vibration information; and
an output unit that outputs presentation information on at least one of condition monitoring, quality control, and predictive maintenance of the object, based on the spectrogram.

2. The processing system according to claim 1, wherein
the first vibration information is vibration information on a first axis detected by a first vibration sensor, and
the second vibration information is vibration information on a second axis detected by the first vibration sensor.

3. The processing system according to claim 1, wherein
the first vibration information is vibration information on the first axis detected by the first vibration sensor, and
the second vibration information is vibration information on the first axis or a second axis detected by a second vibration sensor disposed at a position different from that of the first vibration sensor.

4. The processing system according to claim 1, wherein
the first vibration information is a first physical quantity that is acceleration, velocity, displacement, angular acceleration, angular velocity, or angle of a first axis among an x-axis, a y-axis, and a z-axis, and
the second vibration information is the first physical quantity of a second axis different from the first axis among the x-axis, the y-axis, and the z-axis.

5. The processing system according to claim 1, wherein
the first vibration information is a first physical quantity that is acceleration, velocity, displacement, angular acceleration, angular velocity, or angle of a first axis among an x-axis, a y-axis, and a z-axis, and
the second vibration information is a second physical quantity different from the first physical quantity, among the acceleration, velocity, displacement, angular acceleration, angular velocity, and angle of the first axis.

6. The processing system according to claim 1, wherein
the output unit outputs the presentation information based on statistical information on the spectrogram.

7. The processing system according to claim 1, wherein
the output unit outputs the presentation information based on a change in the spectrogram over time at a specific frequency or within a specific frequency range.

8. The processing system according to claim 1, wherein
the arithmetic unit obtains a reference spectrogram by smoothing the spectrogram in a time direction, and obtain a difference spectrogram by subtracting the reference spectrogram from the spectrogram, and
the output unit outputs the presentation information based on the difference spectrogram.

9. The processing system according to claim 1, wherein
the arithmetic unit performs an arithmetic operation on a first spectrogram of a first type among three types, the cross-power spectrogram, the cross-phase spectrogram, and the coherence spectrogram, of the first vibration information and the second vibration information, and a second spectrogram of a second type different from the first type among the three types, and
the output unit outputs the presentation information based on the result of the arithmetic operation.

10. The processing system according to claim 1, wherein
the acquisition unit acquires third vibration information of a third channel and fourth vibration information of a fourth channel about the vibration of the object,
the arithmetic unit performs an arithmetic operation on a first spectrogram of a first type among three types, the cross-power spectrogram, the cross-phase spectrogram, and the coherence spectrogram, of the first vibration information and the second vibration information, and a second spectrogram of the first type or a second type different from the first type among three types, the cross-power spectrogram, the cross-phase spectrogram, and the coherence spectrogram, of the third vibration information and the fourth vibration information, and
the output unit outputs the presentation information based on the result of the arithmetic operation.

11. A non-transitory computer-readable storage medium storing a program for causing a computer to function as:
an acquisition unit that acquires first vibration information of a first channel and second vibration information of a second channel about vibration of an object;
an arithmetic unit that calculates a spectrogram including at least one of a cross-power spectrogram, a cross-phase spectrogram, and a coherence spectrogram of the first vibration information and the second vibration information; and
an output unit that outputs presentation information on at least one of condition monitoring, quality control, and predictive maintenance of the object, based on the spectrogram.

12. A processing method comprising:
acquiring first vibration information of a first channel and second vibration information of a second channel about vibration of an object;
calculating a spectrogram including at least one of a cross-power spectrogram, a cross-phase spectrogram, and a coherence spectrogram of the first vibration information and the second vibration information; and
outputting presentation information on at least one of condition monitoring, quality control, and predictive maintenance of the object, based on the spectrogram.
